(19) United States
(12) Patent Application Publication
(10) Pub. No.: US 2025/0391274 A1
(43) Pub. Date: Dec. 25, 2025

(54) SPACETIME TRAJECTORIES IN BOARDING ZONE AND TRUNK LANE OPERATIONS

(71) Applicant: Glydways Inc., South San Francisco, CA (US)

(72) Inventors: Kevin Keogh, South San Francisco, CA (US); Craig Bidstrup, South San Francisco, CA (US)

(21) Appl. No.: 19/244,795

(22) Filed: Jun. 20, 2025

Related U.S. Application Data
(60) Provisional application No. 63/662,657, filed on Jun. 21, 2024.

(51) Int. Cl. G08G 1/00; B60W 30/06; B60W 60/00

(52) U.S. Cl. CPC G08G 1/202; B60W 30/06; B60W 60/0015; B60W 60/00253; B60W 2520/105

(57) ABSTRACT

A method may include, at a control system, receiving a trip request specifying an origin boarding zone and a destination boarding zone, determining a path for the trip request, the path extending from the origin boarding zone and along at least a portion of a trunk lane of a roadway system, assigning the trip request to a vehicle, determining, based at least in part on a location of a parking spot where the vehicle is parked at the origin boarding zone, an estimated transit duration of the vehicle from the parking spot to an entrance to the trunk lane, selecting, based at least in part on the estimated transit duration, a moving position-target from a set of candidate moving position-targets, and causing the vehicle to travel from the parking spot to the trunk lane and travel along the portion of the trunk lane by following the selected moving position-target.

### CROSS-REFERENCE TO RELATED APPLICATION

This application is a nonprovisional patent application of and claims the benefit under 35 U.S.C. § 119 (e) of U.S. Provisional Patent Application No. 63/662,657, filed Jun. 21, 2024, and titled “Vehicle Trajectory Control for Autonomous Vehicles in a Transportation System,” the contents of which are incorporated herein by reference in its entirety.

### FIELD

The described embodiments relate generally to transportation systems, and, more particularly, to transportation systems using multiple vehicle trajectory control schemes for autonomous vehicle operation.

### BACKGROUND

Vehicles, such as cars, trucks, vans, buses, trams, and the like, are ubiquitous in modern society. Cars, trucks, and vans are frequently used for personal transportation to transport relatively small numbers of passengers, while buses, trams, and other large vehicles are frequently used for public transportation. Vehicles may also be used for package transport or other purposes. Such vehicles may be driven on roads, which may include surface roads, bridges, highways, overpasses, or other types of vehicle rights-of-way. Driverless or autonomous vehicles may relieve individuals of the need to manually operate the vehicles for their transportation needs.

### SUMMARY

A method of operating a transportation system may include, at a control system configured to determine respective paths for respective vehicles and to provide the respective paths to the respective vehicles, receiving a trip request specifying an origin boarding zone and a destination boarding zone, determining a path for the trip request, the path extending from the origin boarding zone and along at least a portion of a trunk lane of a roadway system, the trunk lane associated with a set of candidate moving position-targets defining vehicle position with respect to time along the trunk lane, assigning the trip request to a vehicle, determining, based at least in part on a location of a parking spot where the vehicle is parked at the origin boarding zone, an estimated transit duration of the vehicle from the parking spot to an entrance to the trunk lane, selecting, based at least in part on the estimated transit duration, a moving position-target from the set of candidate moving position-targets, and causing the vehicle to travel from the parking spot to the trunk lane and travel along the portion of the trunk lane by following the selected moving position-target.

The origin boarding zone may include an output buffer zone for receiving vehicles exiting the origin boarding zone, the destination boarding zone may include an input buffer zone for receiving vehicles entering the destination boarding zone, and selecting the moving position-target may include selecting an available moving position-target that is not assigned to any other vehicle between the output buffer zone at the origin boarding zone and the input buffer zone at the destination boarding zone. The path may extend from the parking spot of the origin boarding zone to an input buffer position of the destination boarding zone. The input buffer position of the destination boarding zone may be an outermost input buffer position. The outermost input buffer position may be a first input buffer position, and the method may further include, in accordance with a determination that a second input buffer position downstream of the first input buffer position is scheduled to be unoccupied at a time of arrival of the vehicle at the destination boarding zone, sending an updated trajectory segment to the vehicle, the updated trajectory segment terminating at the second input buffer position.

Selecting the moving position-target from the set of candidate moving position-targets includes selecting a moving position-target that is configured to pass the origin boarding zone after the vehicle arrives at the entrance to the trunk lane. The set of candidate moving position-targets may define non-intersecting vehicle positions along the trunk lane as a function of time.

The method may further include causing the vehicle to delay the travel from the parking spot to the trunk lane for a delay duration, the delay duration based at least in part on a time when the moving position-target is configured to pass the origin boarding zone.

The method may further include determining a spacetime trajectory for the vehicle, the spacetime trajectory defining at least a position, a speed, and an acceleration of the vehicle as a function of time from the parking spot to the moving position-target, and causing the vehicle to travel from the parking spot to the trunk lane may include causing the vehicle to traverse the spacetime trajectory.

A method of operating a transportation system may include, at a control system configured to determine respective paths for respective vehicles and to provide the respective paths to the respective vehicles, detecting an upcoming arrival of a vehicle at a destination boarding zone, wherein the vehicle is travelling along a path that terminates at an outermost input buffer position of a set of input buffer positions at the destination boarding zone, selecting a parking spot at the destination boarding zone for the vehicle, in accordance with a determination that a downstream input buffer position of the set of input buffer positions is scheduled to be unoccupied at a time of arrival of the vehicle at the destination boarding zone, sending an updated trajectory segment to the vehicle, the updated trajectory segment extending the path to the downstream input buffer position, and including a path segment extending from the downstream input buffer position to the parking spot, and causing the vehicle to traverse the updated trajectory segment.

Travelling along the path may include following a moving position-target defining vehicle position with respect to time along a trunk lane that is connected to the destination boarding zone. Selecting the parking spot may include selecting a parking spot that is scheduled to be unoccupied at a time of arrival of the vehicle at the parking spot.

The method may further include comparing the updated trajectory segment to respective trajectory segments of other respective vehicles scheduled to travel through the destination boarding zone during a same time as the vehicle, and in accordance with a determination that the updated trajectory segment intersects a respective trajectory segment of at least one of the other respective vehicles, delaying a departure of the vehicle from the downstream input buffer position to the parking spot along the updated trajectory segment. The method may further include, in accordance with a determination that the updated trajectory segment does not intersect any of the respective trajectory segments of the other respective vehicles, initiating the departure of the vehicle from the downstream input buffer position to the parking spot along the updated trajectory segment.

A method of operating a transportation system, may include, at a control system configured to determine respective paths for respective vehicles and to provide the respective paths to the respective vehicles, receiving a trip request specifying an origin boarding zone and a destination boarding zone, selecting a vehicle for the trip request, determining a deconflicted spacetime trajectory for the trip request, the deconflicted spacetime trajectory configured to avoid contact with other vehicles in the transportation system and extending from the origin boarding zone, along at least a portion of a trunk lane of a roadway system, to the destination boarding zone, the determining including, for a first trajectory segment from a parking spot at the origin boarding zone to the trunk lane, comparing the first trajectory segment to respective trajectory segments of other respective vehicles scheduled to travel in the origin boarding zone during a same time as the vehicle, and selecting a departure time from the parking spot that results in the first trajectory segment avoiding all other respective trajectory segments, and for a second trajectory segment along the trunk lane, the trunk lane associated with a set of moving position-targets that define non-intersecting vehicle positions along the trunk lane as a function of time, selecting a moving position-target that is not assigned to another vehicle.

The method may further include determining a path for the trip request, the path extending from the origin boarding zone to the destination boarding zone.

The method may further include providing, to the vehicle, a parametric representation of the deconflicted spacetime trajectory that defines a position setpoint, a velocity setpoint, and an acceleration setpoint for the vehicle as a function of time. The parametric representation of the deconflicted spacetime trajectory may be configured to cause the vehicle to traverse the first trajectory segment and the second trajectory segment.

The method may further include causing the vehicle to begin traversing the deconflicted spacetime trajectory at the departure time.

The vehicle may be a first vehicle, the parking spot may be a first parking spot, and the respective trajectory segments of the other respective vehicles includes a third trajectory segment of a second vehicle that is travelling from the trunk lane to a second parking spot.

A method of operating a transportation system may include, at a control system configured to determine respective paths for respective vehicles and to provide the respective paths to the respective vehicles, receiving a trip request specifying an origin boarding zone and a destination boarding zone, selecting a vehicle for the trip request, determining a path for the trip request, the path extending from the origin boarding zone, along at least a portion of a trunk lane of a roadway system, to the destination boarding zone, receiving an indication that the vehicle is prepared to depart from a parking spot at the origin boarding zone, and in response to receiving the indication, determining a proposed trajectory segment from a parking spot at the origin boarding zone to the trunk lane of the roadway system, determining whether the proposed trajectory segment will cause the vehicle to contact other respective vehicles traversing other respective trajectory segments in the origin boarding zone, and in response to determining that the proposed trajectory segment will not cause the vehicle to contact the other respective vehicles traversing the other respective trajectory segments in the origin boarding zone, causing the vehicle to depart the parking spot and travel along the proposed trajectory segment in the origin boarding zone.

The method may further include, in response to determining that the proposed trajectory segment will cause the vehicle to contact at least one of the other respective vehicles traversing the other respective trajectory segments in the origin boarding zone, delaying the vehicle's departure from the parking spot. The proposed trajectory segment may be a first proposed trajectory segment, the other respective vehicles traversing the other respective trajectory segments may be first other respective vehicles traversing first respective trajectory segments, and the method may further include, after delaying the vehicle's departure from the parking spot for a duration, determining whether a second proposed trajectory segment from the parking spot at the origin boarding zone to the trunk lane of the roadway system will cause the vehicle to contact second other respective vehicles traversing second other respective trajectory segments in the origin boarding zone, and in response to a determination that the second proposed trajectory segment will not cause the vehicle to contact the second other respective vehicles traversing the second other respective trajectory segments in the origin boarding zone, causing the vehicle to depart the parking spot and travel along the second proposed trajectory segment in the origin boarding zone. The duration may be a first duration, and in response to a determination that the second proposed trajectory segment will cause the vehicle to contact at least one of the second other respective vehicles traversing the second other respective trajectory segments in the origin boarding zone, delaying the vehicle's departure from the parking spot for a second duration.

The indication that the vehicle is prepared to depart from the parking spot at the origin boarding zone may be received from the vehicle after a door of the vehicle is closed. Determining whether the proposed trajectory segment will cause the vehicle to contact other respective vehicles traversing other respective trajectory segments in the origin boarding zone may include determining whether the proposed trajectory segment will cause at least a portion of the vehicle to occupy a same physical location as at least a portion of another vehicle at the same time. The at least one of the other respective vehicles may be travelling from the trunk lane of the roadway system to another parking spot at the origin boarding zone.

A method of operating a transportation system may include, at a control system configured to determine respective paths for respective vehicles and to provide the respective paths to the respective vehicles, detecting arrival of a vehicle at an input buffer position of a boarding zone, the input buffer position defining a predefined position in the boarding zone, causing the vehicle to pause at the input buffer position, determining a proposed trajectory segment from the input buffer position to a parking spot at the boarding zone, determining whether the proposed trajectory segment will cause the vehicle to contact other respective vehicles traversing other respective trajectory segments in the boarding zone, and in response to determining that the proposed trajectory segment will not cause the vehicle to contact the other respective vehicles traversing the other respective trajectory segments in the boarding zone, causing the vehicle to depart the input buffer position and travel to the parking spot.

The method may further include, in response to determining that the proposed trajectory segment will cause the vehicle to contact at least one of the other respective vehicles traversing the other respective trajectory segments in the boarding zone, delaying the vehicle's departure from the input buffer position. The proposed trajectory segment may be a first proposed trajectory segment, the other respective vehicles traversing the other respective trajectory segments may be first other respective vehicles traversing first respective trajectory segments, and the method may further include, after delaying the vehicle's departure from the input buffer position for a duration, determining whether a second proposed trajectory segment from the input buffer position to the parking spot at the boarding zone will cause the vehicle to contact second other respective vehicles traversing second other respective trajectory segments in the boarding zone, and in response to a determination that the second proposed trajectory segment will not cause the vehicle to contact the second other respective vehicles traversing the second other respective trajectory segments in the boarding zone, causing the vehicle to depart the input buffer position and travel along the second proposed trajectory segment to the parking spot.

The input buffer position may be a downstream input buffer position that is downstream of an outermost input buffer position of a set of input buffer positions at the boarding zone, and the method may further include, prior to arrival of the vehicle at the input buffer position, detecting an upcoming arrival of the vehicle at the boarding zone, wherein the vehicle is travelling along an initial path that terminates at the outermost input buffer position, and in accordance with a determination that the downstream input buffer position is scheduled to be unoccupied at a time of arrival of the vehicle at the boarding zone, sending an updated trajectory segment to the vehicle, the updated trajectory segment terminating at the downstream input buffer position.

Determining whether the proposed trajectory segment will cause the vehicle to contact other respective vehicles traversing other respective trajectory segments in the boarding zone may include determining whether the proposed trajectory segment will cause at least a portion of the vehicle to occupy a same physical location as at least a portion of another vehicle at the same time.

The proposed trajectory segment from the input buffer position to the parking spot at the boarding zone may define at least a position setpoint, a velocity setpoint, and an acceleration setpoint for the vehicle as a function of time.

The method may further include, in response to detecting arrival of the vehicle at the input buffer position, selecting the parking spot from a set of candidate parking spots at the boarding zone.

A method of operating a transportation system may include, at a control system configured to determine respective paths for respective vehicles and to provide the respective paths to the respective vehicles, detecting arrival of a vehicle at a buffer position proximate an intersection of a first trunk lane and a second trunk lane, the buffer position defining a predefined position in a first segment of the first trunk lane, causing the vehicle to pause at the buffer position, selecting a moving position-target from a set of candidate moving position-targets associated with a second segment of the first trunk lane, determining a proposed trajectory segment from the buffer position, through the intersection, and to the selected moving position-target, determining whether the proposed trajectory segment will cause the vehicle to contact other respective vehicles traversing other respective trajectory segments through the intersection, and in response to determining that the proposed trajectory segment will not cause the vehicle to contact the other respective vehicles traversing the other respective trajectory segments through the intersection, causing the vehicle to depart the buffer position and travel along the proposed trajectory segment to the moving position-target.

The method may further include, in response to determining that the proposed trajectory segment will cause the vehicle to contact at least one of the other respective vehicles traversing the other respective trajectory segments through the intersection, delaying the vehicle's departure from the buffer position. The proposed trajectory segment may be a first proposed trajectory segment, the other respective vehicles traversing the other respective trajectory segments may be first other respective vehicles traversing first respective trajectory segments, and the method may further include, after delaying the vehicle's departure from the buffer position for a duration, determining whether a second proposed trajectory segment from the buffer position, through the intersection, and to the selected moving position-target will cause the vehicle to contact second other respective vehicles traversing second other respective trajectory segments through the intersection, and in response to a determination that the second proposed trajectory segment will not cause the vehicle to contact the second other respective vehicles traversing the second other respective trajectory segments through the intersection, causing the vehicle to depart the buffer position and travel along the second proposed trajectory segment to the moving position-target.

The moving position-target may be a first moving position-target, and the proposed trajectory segment extends between a pair of adjacent second moving position-targets associated with the second trunk lane. The moving position-target may be a first moving position-target, and prior to arriving at the buffer position, the vehicle may be following a second moving position-target associated with the first segment of the first trunk lane. The proposed trajectory segment may define at least a position setpoint, a velocity setpoint, and an acceleration setpoint for the vehicle as a function of time.

A method of operating a transportation system may include, at a first control system of a first roadway system, receiving a trip request specifying an origin boarding zone in the first roadway system and a destination boarding zone in a second roadway system, wherein the first control system is configured to determine vehicle paths within the first roadway system and the second roadway system includes a second control system configured to determine vehicle paths within the second roadway system, selecting a vehicle for the trip request, determining a first path segment for the trip request, the first path segment extending from the origin boarding zone, along at least a portion of a first trunk lane of the first roadway system, to a transition zone between the first roadway system and the second roadway system, selecting a first moving position-target from a set of first candidate moving position-targets defined along the first trunk lane, and requesting, from the second control system of the second roadway system, a second path segment extending from the transition zone, along at least a portion of a second trunk lane of the second roadway system, to the destination boarding zone, and a second moving position-target from a set of second candidate moving position-targets defined along the second trunk lane. The method may further include causing the vehicle to travel along the portion of the first trunk lane by following the first moving position-target, and at the transition zone, transition from following the first moving position-target to following the second moving position-target. The first trunk lane of the first roadway system may be contiguous with the second trunk lane of the second roadway system. Selecting the vehicle for the trip request may include selecting the vehicle from a set of candidate vehicles that are located in the first roadway system.

The method may further include, in response to the vehicle transitioning from following the first moving position-target to following the second moving position-target, deregistering the vehicle from a vehicle fleet associated with the first control system. The vehicle fleet may be a first vehicle fleet, and the method may further include, at the second control system and in response to the vehicle transitioning from following the first moving position-target to following the second moving position-target, registering the vehicle in a second vehicle fleet associated with the second control system. The first control system may select vehicles for trip requests originating at origin boarding zones in the first roadway system from the first vehicle fleet, and the second control system may select vehicles for trip requests originating at origin boarding zones in the second roadway system from the second vehicle fleet.

The first control system may include a boarding zone router and a first trunk router, the first trunk router may be configured to assign moving position-targets from the set of first candidate moving position-targets, the second control system may include a second trunk router configured to assign moving position-targets from a set of second candidate moving position-targets, and the boarding zone router of the first control system requests the second moving position-target from the second trunk router.

A method of operating a transportation system, may include, at a first control system of a first roadway system, receiving a trip request specifying an origin boarding zone in the first roadway system and a destination boarding zone in a second roadway system, wherein the first control system is configured to determine vehicle paths within the first roadway system. The method may further include selecting a vehicle for the trip request, determining a path segment for the trip request, the path segment extending from the origin boarding zone, along at least a portion of a first trunk lane of the first roadway system, to an intersection joining the first trunk lane of the first roadway system to a second trunk lane of the second roadway system, selecting a first moving position-target from a set of first candidate moving position-targets defined along the first trunk lane, and causing the vehicle to travel along the portion of the first trunk lane by following the first moving position-target. The method may further include, at a second control system of the second roadway system, detecting arrival of the vehicle at a buffer position proximate the intersection, the buffer position defining a predefined position in a first segment of the first trunk lane, causing the vehicle to pause at the buffer position, selecting a second moving position-target from a set of second candidate moving position-targets defined along the second trunk lane, determining a proposed trajectory segment from the buffer position, through the intersection, and to the selected second moving position-target, determining whether the proposed trajectory segment will cause the vehicle to contact other respective vehicles traversing other respective trajectory segments through the intersection, and in response to determining that the proposed trajectory segment will not cause the vehicle to contact the other respective vehicles traversing the other respective trajectory segments through the intersection, causing the vehicle to depart the buffer position and travel along the proposed trajectory segment to the second moving position-target.

The method may further include, in response to determining that the proposed trajectory segment will cause the vehicle to contact at least one of the other respective vehicles traversing the other respective trajectory segments through the intersection, delaying the vehicle's departure from the buffer position. The proposed trajectory segment may be a first proposed trajectory segment, the other respective vehicles traversing the other respective trajectory segments may be first other respective vehicles traversing first respective trajectory segments, and the method may further include, after delaying the vehicle's departure from the buffer position for a duration determining whether a second proposed trajectory segment from the buffer position, through the intersection, and to the selected second moving position-target will cause the vehicle to contact second other respective vehicles traversing second other respective trajectory segments through the intersection, and in response to a determination that the second proposed trajectory segment will not cause the vehicle to contact the second other respective vehicles traversing the second other respective trajectory segments through the intersection, causing the vehicle to depart the buffer position and travel along the second proposed trajectory segment to the second moving position-target.

The first control system may select vehicles for trip requests originating at origin boarding zones in the first roadway system from a first vehicle fleet, the first vehicle fleet including vehicles located in the first roadway system, and the second control system may select vehicles for trip requests originating at origin boarding zones in the second roadway system from a second vehicle fleet, the second vehicle fleet including vehicles located in the second roadway system.

The buffer position may be a downstream buffer position that is downstream of an outermost buffer position at the intersection, and the method may further include, at the second control system detecting an upcoming arrival of the vehicle at the intersection, wherein the vehicle is travelling along an initial path that terminates at the outermost buffer position, and in accordance with a determination that the downstream buffer position is scheduled to be unoccupied at a time of arrival of the vehicle at the intersection, sending an updated trajectory segment to the vehicle, the updated trajectory segment terminating at the downstream buffer position.

The path segment may be a first path segment, and the method may further include, at the second control system, determining a second path segment for the trip request, the second path segment extending from the intersection to the destination boarding zone. The first path segment and the second path segment may define an entire path from an origin parking spot at the origin boarding zone to a destination parking spot at the destination boarding zone.

A transportation system may include a first control system of a first roadway system, the first control system configured to receive a trip request specifying an origin boarding zone in the first roadway system and a destination boarding zone in a second roadway system, select a vehicle for the trip request, determine a first path segment for the trip request, the first path segment extending from the origin boarding zone, along at least a portion of a first trunk lane of the first roadway system, to a transition zone between the first roadway system and the second roadway system, select a first moving position-target from a set of first candidate moving position-targets defined along the first trunk lane, and request, from a second control system of the second roadway system a second path segment extending from the transition zone, along at least a portion of a second trunk lane of the second roadway system, to the destination boarding zone, and a second moving position-target from a set of second candidate moving position-targets defined along the second trunk lane. The first control system may be further configured to cause the vehicle to travel along the portion of the first trunk lane by following the first moving position-target, and at the transition zone, transition from following the first moving position-target to following the second moving position-target.

The first trunk lane of the first roadway system may be contiguous with the second trunk lane of the second roadway system. Selecting the vehicle for the trip request may include selecting the vehicle from a set of candidate vehicles that is located in the first roadway system. The first control system may be further configured to, in response to the vehicle transitioning from following the first moving position-target to following the second moving position-target, deregister the vehicle from a vehicle fleet associated with the first control system.

The first control system may be further configured to cause the vehicle to depart the origin boarding zone in response to a determination that a proposed trajectory segment from a parking spot at the origin boarding zone to the first trunk lane will not cause the vehicle to contact another respective vehicle traversing another respective trajectory segment through the origin boarding zone.

The first control system may include a boarding zone router and a first trunk router, the first trunk router may be configured to assign moving position-targets from the set of first candidate moving position-targets, the second control system may include a second trunk router configured to assign moving position-targets from the set of second candidate moving position-targets, and the boarding zone router of the first control system requests the first moving position-target from the first trunk router and requests the second moving position-target from the second trunk router.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A depicts a portion of an example roadway of a transportation system.

FIG. 1B depicts a schematic representation of an example transportation system.

FIG. 2A depicts a map of an example roadway system of a transportation system.

FIG. 2B depicts a portion of a roadway system including an example boarding zone.

FIGS. 3A-3D depict a portion of an example trunk lane of a roadway system.

FIG. 4A depicts a portion of an example roadway with moving position-targets.

FIG. 4B depicts a plot showing velocity and acceleration over time for a moving position-target.

FIGS. 5A-5C depict an example boarding zone and various vehicle operations within the boarding zone.

FIGS. 6A-6B depict a portion of a boarding zone, illustrating example trajectory deconfliction techniques for contested zones.

FIGS. 7A-7D depict a portion of a boarding zone, illustrating example boarding zone departure and arrival operations using trajectory deconfliction techniques.

FIGS. 7E-7F depict a portion of a roadway system including an example boarding zone, illustrating example techniques for transitioning vehicles between trunk lanes and boarding zones.

FIGS. 8A-8B depict an example trunk lane intersection using moving position-target deconfliction techniques.

FIGS. 9A-9D depict example trunk lane intersections using trajectory deconfliction techniques.

FIGS. 10A-10B depict a portion of an example roadway, illustrating example vehicle merging operations.

FIGS. 11A-11B depict example transportation systems and techniques for joining separately managed transportation systems.

FIGS. 12A-12C depict an example vehicle.

FIGS. 13A-13B depict the vehicle of FIGS. 12A-12B with its doors open.

FIG. 14 illustrates an electrical block diagram of an electronic device that may perform the operations described herein.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as can be included within the spirit and scope of the described embodiments as defined by the appended claims.

The embodiments herein are generally directed to a transportation system in which numerous vehicles may be autonomously operated to transport passengers and/or freight along roadways within a roadway system or network. For example, a transportation system or service may provide a fleet of vehicles that operate in a roadway system to pick up and drop off passengers at pre-set locations or stops (e.g., boarding zones). In some cases, the vehicles may also pick up and drop off passengers at dynamically selected locations outside of boarding zones.

Autonomous operation of a vehicle is a complicated task, however, and the particular techniques or schemes employed by the transportation system to control the vehicles on the roadway may have a dramatic effect on the operation of the overall system. For example, some vehicle control schemes may be susceptible to causing or propagating traffic jams or other disturbances that negatively affect the operation and/or efficiency of the system. Furthermore, the transportation system should be designed to reduce or minimize the possibility of collisions or other adverse encounters between vehicles. However, in some cases, control schemes that are optimized or tuned to avoid traffic disturbances, collisions, or other adverse encounters may be inflexible, space inefficient, or may otherwise reduce the quality of the user experience. Accordingly, described herein are techniques, systems, and methods for controlling autonomous vehicles in a transportation system in order to provide high levels of safety and efficiency, all while maintaining a superior user experience.

For example, a transportation system as described herein may be configured to determine a complete path, through the system, for each trip request. As used herein, a path may define the particular portions of roadways and boarding zones (and optionally other traversable areas) of a transportation system that a vehicle traverses in order to complete a trip request. For example, a user may request a trip from an origin location to a destination location. In response, the transportation system may determine a path from the origin location to the destination location. Additionally, the transportation system may associate the path with a particular departure time, and may determine a spacetime trajectory, for a vehicle, that corresponds to the path. As used herein, a spacetime trajectory (or simply trajectory) may define the position, velocity, and acceleration of a vehicle, as a function of time, that, when traversed or executed by a vehicle, causes the vehicle to traverse a particular path (or segment of a path). Accordingly, once a spacetime trajectory is determined for a particular trip, the transportation system can predict the location (as well as the velocity and acceleration) of the vehicle in the transportation system at any time throughout the trip. Further, when determining spacetime trajectories for trips, the transportation system can produce trajectories that do not intersect or interfere with one another. More particularly, each spacetime trajectory may be deconflicted with respect to all other spacetime trajectories within the transportation system. As used herein, a deconflicted trajectory corresponds to a trajectory that does not intersect or interfere with any other trajectories (e.g., a vehicle traversing a spacetime trajectory will not collide with any other vehicles traversing their respective spacetime trajectories). As described herein, the transportation system may be configured to operate all vehicles in a fully deconflicted manner (e.g., the system may be configured so that all vehicle trajectories are fully deconflicted from origin to destination, such that if all vehicles operate according to their predefined trajectories, there are no intersecting or conflicting vehicle trajectories). Moreover, by providing fully deconflicted trajectories for each vehicle, the vehicles themselves do not need to mediate potential conflicts between themselves under nominal operating conditions. As one example, the vehicles do not need to determine how to move safely in a boarding zone, since their trajectory in the boarding zone is predefined to be safe (e.g., deconflicted) by the control system. Each vehicle simply needs to follow its assigned trajectory (including through regions that use different deconfliction schemes). Of course, each vehicle also employs a local autonomy system to avoid adverse vehicle interactions in off-nominal or anomalous system operation conditions (e.g., each vehicle includes sensors and a controller to avoid adverse interactions with other vehicles, objects, or the like).

Spacetime trajectories may be defined or represented in various ways. For example, as described herein, a spacetime trajectory may be defined by a parametric representation that defines position, velocity, and acceleration as a function of time. A vehicle may use the parametric representation to travel along the roadway system according to the prescribed spacetime trajectory. As described herein, spacetime trajectories may be generated such that at least a portion of the trajectory coincides with a moving position-target (e.g., a vehicle following a particular spacetime trajectory along a trunk lane will be following a selected moving position-target). Spacetime trajectories may also be generated without reference to moving position-targets, such as for paths through contested zones such as boarding zones, intersections, and the like.

In order to provide a high level of safety, efficiency, and user experience, different areas of a transportation system may employ different deconfliction schemes in order to produce deconflicted trajectories. For example, along trunk lanes (e.g., roadways configured for continuous vehicle flow), the transportation system may direct vehicles to follow predefined moving position-targets. The moving position-targets may define valid, deconflicted vehicle positions along the trunk lane, and a trajectory segment for a vehicle along a trunk lane may coincide with a particular moving position-target. Since each moving position-target may be deconflicted by definition, deconfliction along a trunk lane may be achieved by assigning vehicles to moving position-targets.

In areas of the transportation system where vehicles need to cross paths or otherwise perform more sophisticated vehicle maneuvers (e.g., boarding zones, intersections, parking lots and garages, service and repair facilities, etc.), predefined moving position-targets may not be well suited to enabling dynamic vehicle operations. For example, in a boarding zone, it is advantageous for the system to be flexible enough to allow vehicles to depart when a passenger is ready, and not mandate strict departure times. In such cases, a different deconfliction scheme may be employed. For example, in a boarding zone, proposed trajectory segments of a vehicle attempting to traverse the boarding zone (e.g., to embark on a trip) may be compared to other trajectory segments of other vehicles in order to determine when the vehicle can safely traverse its path through the boarding zone. Such trajectory comparisons may be used to determine when vehicles can begin their trips, and can ensure that their trajectory is deconflicted through the boarding zone. As described herein, similar deconfliction and movement initiation schemes may be used at intersections, parking garages, or other areas where vehicles may cross paths or otherwise not follow predetermined moving position-targets. By determining trajectories that employ multiple different deconfliction schemes across a trip, the transportation system described herein can provide safe vehicle operation (e.g., each trip is predefined so as to avoid collisions or other adverse encounters), while also providing, efficient and user-friendly operations. As used herein, areas where vehicle operations require the use of potentially intersecting vehicle trajectories (e.g., where predefined deconflicted moving position-targets are not employed or available) may be referred to as contested zones or contested areas. Further, intersecting vehicle trajectories refer to trajectories that cause vehicles to collide (or come within a threshold distance of colliding). It will be understood that trajectories are defined both in space and time. As such, trajectories that intersect in space may not be intersecting if they do not also intersect in time.

As described herein, a dispatch system (or a control system more generally) may be used to produce the paths and trajectories for a requested trip. The dispatch system may include or instantiate a set of vehicle routers that are each responsible for the vehicles entering and exiting a certain area of the transportation system (e.g., areas that use a trajectory comparison deconfliction scheme, such as boarding zones, intersections, parking lots and garages, service and repair facilities, etc.). As described herein, a router for a boarding zone may determine a path and optionally a trajectory for each vehicle that is scheduled to traverse through the boarding zone. In the case of an origin boarding zone, the path may extend from the origin boarding zone, along at least a portion of at least one trunk lane, and to a destination boarding zone (or another area where a trajectory comparison deconfliction scheme is used). When the vehicle arrives at the destination boarding zone, the responsibility and/or authority for the vehicle (and its path) may be transferred to the router for the destination boarding zone, which provides the vehicle with instructions (e.g., paths, trajectories, etc.) for travelling in or through the destination boarding zone. Similar vehicle routers and vehicle routing operations may be used at any area where trajectory comparison deconfliction schemes are used (e.g., contested zones), such as intersections, parking lots, garages, and the like.

The use of a trajectory comparison scheme for deconfliction in certain areas of a transportation system may facilitate efficient, safe, and dynamic vehicle operations in boarding zones and intersections. These techniques, as well as the manner in which vehicle routing is handed off between routers that implement such schemes, may facilitate the efficient and rapid scaling and interlinking of transportation systems. For example, as discrete transportation systems (e.g., different roadway systems being controlled by different controllers) grow near to each other, they may be linked together by providing a boarding zone or other hand-off point that seamlessly transitions vehicles between the systems. For example, a boarding zone router may be able to admit a vehicle and route it through its roadway system regardless of the origin of the vehicle (e.g., a boarding zone that joins two formerly distinct transportation systems may operate in exactly the same manner as all other boarding zones in the transportation systems). Other features of the transportation systems as described herein facilitate other ways of joining and/or combining discrete transportation systems to allow efficient and seamless scalability.

In some cases, all boarding zones in a given transportation system or roadway system can be bypassed by roadway segments that allow continuous flow (e.g., bypass lanes). Thus, passengers who do not need to access a particular boarding zone can simply bypass that boarding zone, thereby increasing system efficiency and minimizing travel times.

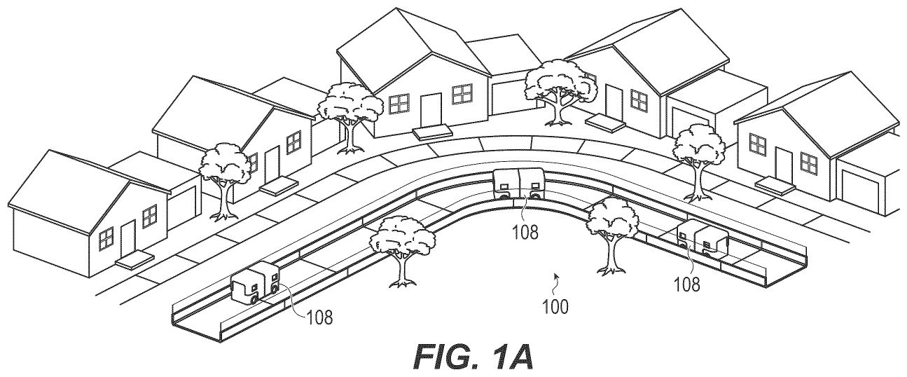

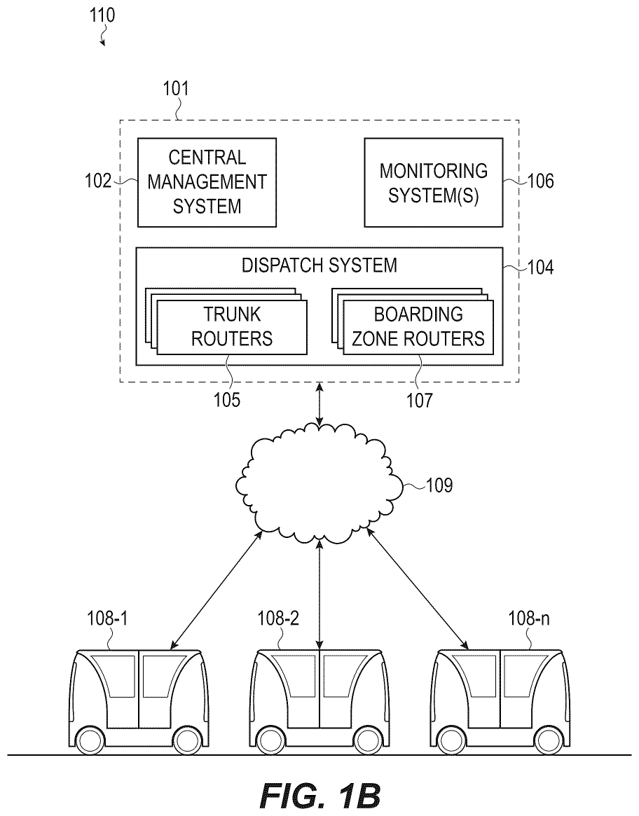

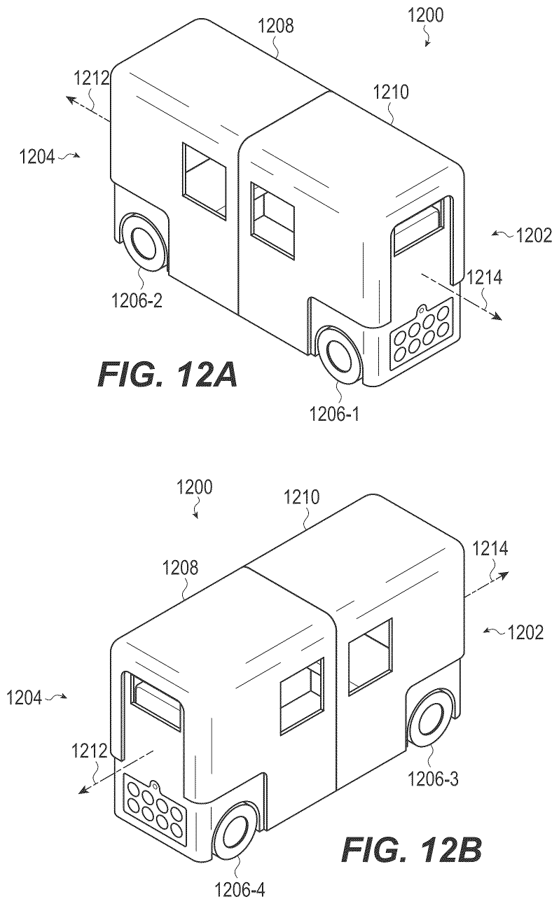

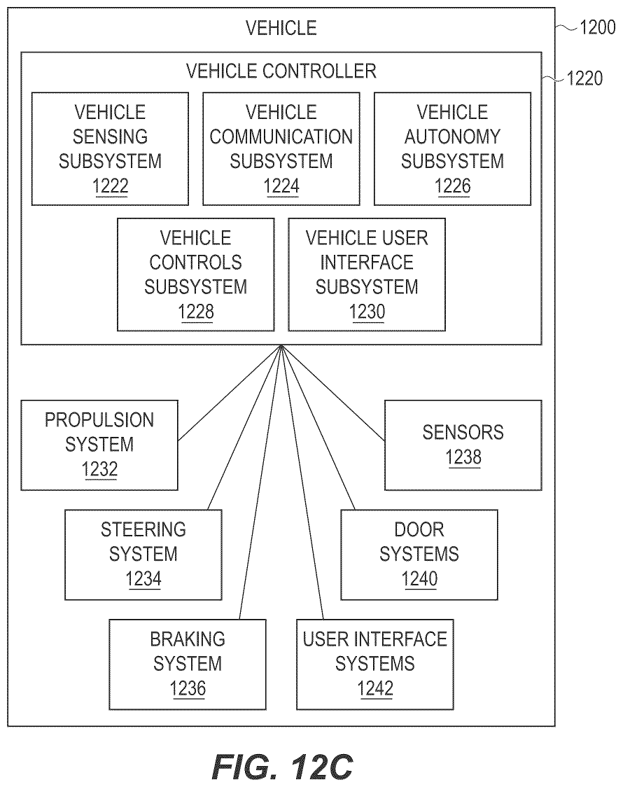

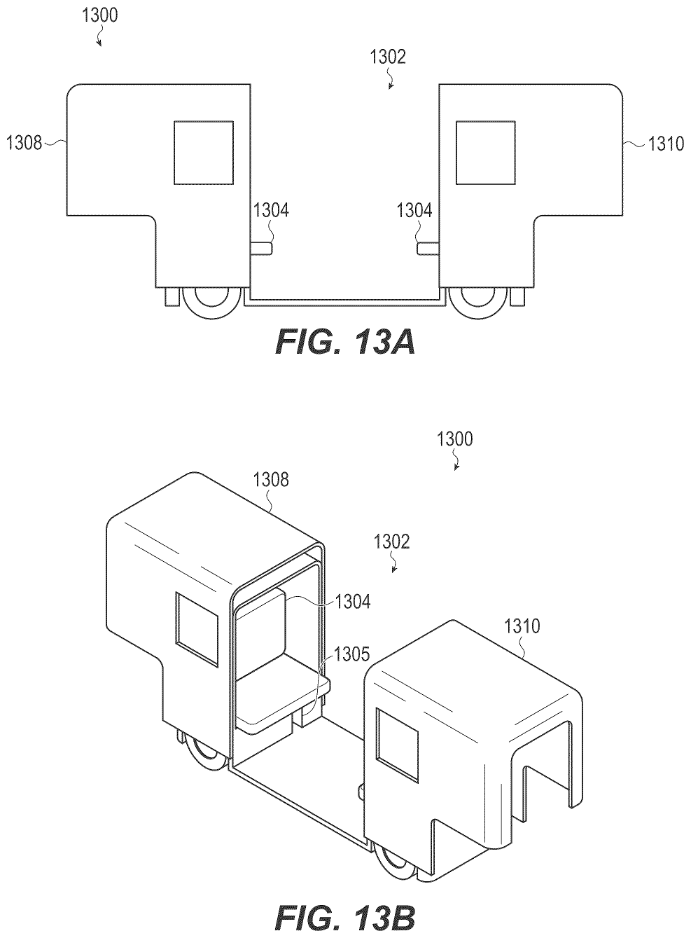

FIG. 1A illustrates a segment of a roadway system 100 for autonomous vehicles 108, in accordance with embodiments described herein. The roadway system 100 that is shown in FIG. 1A is shown at ground level, in a typical urban or suburban environment, though this is not meant to be limiting. Indeed, the roadway system (or simply roadway) may be deployed in any environment or location, including rural locations, entirely or partially inside buildings, away from roadways, on elevated structures, underground, or the like. The roadway 100 is shown with a plurality of four-wheeled autonomous vehicles 108 navigating along the roadway 100. The autonomous vehicles 108 may be autonomous or semi-autonomous vehicles specifically designed for use with the roadway 100. One example type of vehicle for use with the roadway 100 is described with respect to FIGS. 12A-13B, though other types of vehicles may be driven along the roadway 100 instead of or in addition to those described herein. The roadway 100, of which the segment shown in FIG. 1A may only be a small portion, may include multiple segments including straightaways, turns, bridges, tunnels, ramps, and the like. As used herein, a roadway system may describe the set of physical structures of a transportation system where vehicles may operate, and may include trunk lanes, boarding zones, parking facilities (e.g., parking lots, parking garages), maintenance facilities, intersections, merging zones, and the like.

FIG. 1B illustrates an example transportation system 110 that may use the techniques and include the systems and infrastructure described herein. The transportation system 110 includes a control system 101 that can communicate with autonomous vehicles 108 (e.g., vehicles 108-1, . . . , 108-n) of the transportation system 110 (as well as numerous other systems, components, sensors, etc.), to facilitate the operations of the transportation system 110. The control system 101 may include a central management system 102, a dispatch system 104, and one or more track monitoring system(s) 106 (though the control system 101 may include or be implemented by different systems or combinations of systems). The various systems, components, computers, servers, sensors, etc., of the transportation system 110 may communicate via one or more communication systems and/or networks 109. While the control system 101 is shown has having certain discrete subsystems, these subsystems may be combined in some example transportation systems. More particularly, functions and/or operations that are described herein as being performed or otherwise associated with the central management system 102, the dispatch system 104, and the monitoring system 106 may be performed by a single integrated system, or may be split into additional subsystems. Moreover, additional systems, subsystems, modules, controllers, and the like may be included in the control system 101. More generally, a particular association between a function or operation and a portion or subsystem of the control system 101 relates to an example implementation, and in other example implementations, different functions and/or operations are associated with and/or performed by other portions or subsystems.

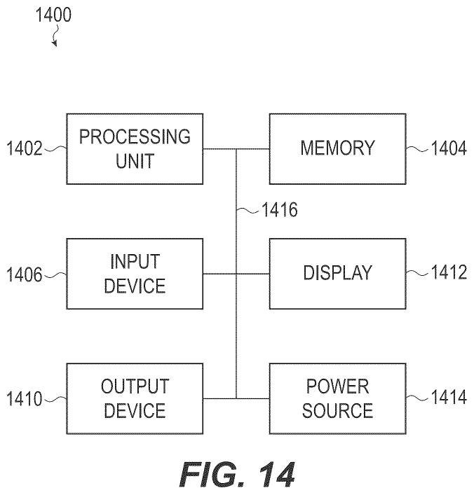

The control system 101 may include and/or be instantiated by one or more electronic devices (e.g., computer systems), such as the electronic device 1400 described with respect to FIG. 14.

The central management system (CMS) 102 may be configured to automatically allocate resources across the network. This may include allocating vehicles to service current trip requests from users, pre-positioning vehicles at boarding zones in anticipation of projected ridership, allocating vehicles to and/or from maintenance and storage facilities in response to vehicle state and current and/or projected system demands.

The CMS 102 may maintain a real-time model of full-system status, including the location of every autonomous vehicle in the system, as well as the assigned trajectories for each vehicle (e.g., the spacetime trajectory that the vehicle is assigned to traverse and/or is currently traversing). As noted herein, the trajectory for a vehicle may define the position, velocity, and acceleration of a vehicle within the transportation system as a function of time, and thus both provides the CMS 102 with information about where each vehicle will be at a given time (e.g., in the future), and also provides individual vehicles with instructions for how to traverse a path within the system. More specifically, the trajectory for a vehicle may define the location and velocity (and optionally acceleration, jerk, and/or other kinematic parameters) of the vehicle at all times as it executes a trip, and the vehicle may autonomously maintain coincidence with the parameters (to an allowable degree of deviation or error). Stated another way, the vehicle is configured to follow (e.g., maintain coincidence with) its position and velocity targets (as well as acceleration, jerk, and/or other parameter targets) as defined by the vehicle trajectory, such that the vehicle is always at its expected position and speed at the expected time. It will be understood that a spacetime trajectory may specify more or fewer (or different) sets of parameters for a vehicle. For example, a spacetime trajectory may define the position of a vehicle with respect to time, and the particular velocity and acceleration of the vehicle may not be predetermined by the spacetime trajectory. As another example, a spacetime trajectory may define a position and a velocity of the vehicle with respect to time. Many of the techniques described herein may be used with various implementations of spacetime trajectories, such as spacetime trajectories that define only position with respect to time.

The CMS 102 may also facilitate both automated and human supervision of the entire transportation system 110. For example, the CMS 102 may receive information from other systems or components of the transportation system 110 (e.g., vehicles, sensors, the track monitoring system 106, the dispatch system 104, etc.), and make adjustments to the system as necessary.

In some cases, the CMS 102 receives trip requests (and optionally other information) from users of the system. Trip requests may include information such as the identity of the requestor, an origin location (e.g., a boarding zone or other location where the user is to be picked up), a destination location (e.g., a boarding zone or other location where the user is to be dropped off), and, optionally, a requested trip start time (e.g., a time at which the vehicle should arrive at the origin location) or trip end time (e.g., a time at which the vehicle should arrive at the destination location). Trip requests may be sent to the CMS 102 via smartphones, kiosks (e.g., at boarding zones or other locations), computers, conventional telephones, wearable devices, or any other suitable device and/or communication technique. The CMS 102 may include and/or be instantiated by one or more electronic devices, (e.g., computer systems), such as the electronic device 1400 described with respect to FIG. 14.

In some cases, the control system 101 may determine paths for trip requests. For example, based on a trip request that specifies an origin location (e.g., origin boarding zone) and destination location (e.g., destination boarding zone), the control system 101 may determine a path, through the transportation system, that extends from the origin boarding zone, along at least a portion of a trunk lane of the roadway system, to the destination boarding zone. In some cases, paths are generated by the CMS 102 (e.g., a vehicle routing or path generating subsystem of the CMS 102), the dispatch system 104, or another subsystem or module of the control system 101. A path for a vehicle may be independent of time, and may simply define the particular roadways or other transportation system segments or zones that the vehicle will traverse from the origin to the destination locations.

The control system 101 may include a dispatch system 104. The dispatch system 104 may determine the trajectories for vehicles and may generally control how the vehicles travel throughout the transportation system. The dispatch system 104 may include trunk router(s) 105 and boarding zone router(s) 107.

Trunk routers may manage vehicle allocations along associated trunk lanes. For example, a trunk router may define or otherwise manage moving position-targets along its associated trunk lane(s), and may manage vehicle reservations on the moving position-targets. For example, in response to a request from a boarding zone router 107, a trunk router 105 may reserve a moving position-target for a vehicle that is departing from the boarding zone associated with the boarding zone router 107 and convey that reservation to the boarding zone router 107. The trunk routers 105 may maintain a record of all moving position-target reservations and the vehicles to which a moving position-target is assigned.

Boarding zone routers 107 may manage vehicle departures and arrivals at associated boarding zones. Boarding zone routers 107 may determine when vehicles can depart from parking spots in order to begin a trip, and when vehicles can enter parking spots in order to conclude a trip. A boarding zone router 107 may perform trajectory deconfliction within an associated boarding zone, and may use the results of the trajectory deconfliction to determine when vehicles can travel through the boarding zone. For example, a boarding zone router 107 may compare a proposed trajectory segment of a vehicle that is waiting to depart to other known trajectories through the boarding zone, and may instruct the vehicle to depart once it determines that its proposed trajectory segment is deconflicted. Boarding zone routers 107 may also request moving position-targets from trunk routers that manage trunk lanes that are connected to the boarding zone (and on which a vehicle is assigned to travel). The boarding zone routers 107 may then determine a vehicle departure time, trajectory, and/or other vehicle operational parameters for a departing vehicle based on the particular moving position-target that is assigned to (e.g., reserved for) that vehicle.

A boarding zone router 107 may be one example of a node router. Node routers may refer to routers that manage departures and arrivals at particular nodes in the transportation system (e.g., boarding zones, intersections, transition zones between roadways, parking lots, and the like). As used herein, nodes may generally refer to locations, areas, or regions in the transportation system that are connected to and/or accessible by trunk lanes. Nodes may act as origin, destination, or intermediate locations of a path. As described herein, each trip may begin and end at a node (e.g., an origin and a destination boarding zone), and may pass through zero or more intermediate nodes. Moreover, each segment of a vehicle's journey may begin and end at a node. For example, as described herein, a first segment of a vehicle trajectory may extend from a first node (origin boarding zone), along a trunk lane, to a second node (e.g., an intersection).

Node routers may perform the same or similar operations as boarding zone routers, but need not be associated with a boarding zone. For example, node routers may perform trajectory deconfliction within contested zones managed by the node routers, and may use the results of the trajectory deconfliction to determine when vehicles can travel through the contested zones. Node routers may also request moving position-targets from trunk routers that manage the trunk lanes that are connected to the node. The node routers may then determine a vehicle departure time, trajectory, and/or other vehicle operational parameter for a departing vehicle based on the particular moving position-target that is assigned to (e.g., reserved for) that vehicle. The node routers may ultimately provide, to a vehicle, information that will cause the vehicle to travel to another node (controlled by another node router). For example, a node router for a first node may provide a trajectory extending from the first node to a next node along the vehicle's path (e.g., a next boarding zone, a next intersection, or the like). As described herein, an entire trajectory for a vehicle (e.g., to cause the vehicle to traverse an assigned path) may be provided by one or more node routers (e.g., boarding zone routers, intersection routers, etc.).

The control system 101 may also include one or more track monitoring systems (TMS) 106. The track monitoring systems 106 may be positioned at various locations within the transportation system, including along roadways, boarding zones, at storage and maintenance facilities, and the like. The TMS 106 may include sensing systems to detect various conditions and events within the system. The sensing systems may include high-resolution (e.g., 0.2-2 mrad), low-latency (<100 ms), long-range (>600 feet) tri-band redundant sensing systems (lidar, radar, camera), and dual-band redundant wireless communication systems. The TMS 106 may provide automated system monitoring including automated vehicle monitoring and automated intrusion detection and may monitor for and provide low-latency response to any violations of system safety invariants. In some cases, track monitoring systems 106 may be deployed at intervals along a roadway, such as every 140-320 feet along the roadway. The particular interval may depend on geographical conditions, roadway properties (e.g., straights vs. turns vs. elevation changes), etc. Track monitoring systems 106 may also be deployed at boarding zones, maintenance and storage facilities, and the like. In some cases, every location in the transportation system that allows for vehicle travel may include one or more TMS 106.

The transportation system 110 also includes autonomous vehicles 108. The autonomous vehicles 108 may be autonomous or semi-autonomous vehicles specifically designed for use with the transportation system 110. One example type of vehicle 108 is described with respect to FIGS. 12A-13B, though other types of vehicles may be included instead of or in addition to those described herein. The vehicles 108 may be configured to independently and at least semi-autonomously (including fully autonomously) operate according to particular vehicle control schemes established for particular roadway segments and/or other transportation system infrastructure. While certain aspects of vehicle operation may be fully controlled by the vehicle itself, other aspects may be controlled and/or determined by the CMS 102 or the control system 101 more generally. For example, the control system 101 may provide deconflicted vehicle trajectories to the autonomous vehicles 108, and the vehicles may perform vehicle operations (e.g., steering, acceleration, braking, etc.) in order to maintain coincidence with the parameters defined by the trajectories (e.g., position, velocity, acceleration). The autonomous vehicles 108 may also be configured to monitor and account for safety issues such as obstacles, roadway or environmental conditions, etc., and optionally take appropriate evasive or other safety measures, while traversing a trajectory.

As noted, the transportation system 110 may provide various ways for users to request and modify ride requests. For example, kiosks may be provided at boarding zones (or other locations) from which users can schedule, pay for and, optionally, modify ride requests. Kiosks may include touchscreen displays (or other types of displays and/or user interface systems) that can provide information to users and accept input from the users. In some cases, the kiosks may provide information about how to use the kiosks to request rides (and/or about other aspects of the transportation system), such as by presenting audio and/or video tutorials, instructions, and the like.

An example ride scheduling operation at a kiosk is described to illustrate example functionality of the kiosk. A user may initiate a kiosk interaction, such as by touching or tapping a touchscreen display. In response, the kiosk may display a map of potential destinations within the transportation system. A list of those destinations with cost and average ride time may also be displayed. In response to a user selecting a destination (and optionally after the user confirms the destination), the CMS 102 may initiate a ride for that user, as described herein.

In some cases, after selecting (and optionally confirming) a destination, a credential item may be associated with the user and/or the trip request. The credential item may be a mobile phone, smart watch, key fob, or any other device or item that can be used by the system to identify the user (e.g., via optical recognition, near field wireless systems, or the like). In some cases, the credential item may be a multi-function card in the user's possession, or a credential card that is provided to the user (e.g., via the kiosk). The credential card may be enabled for wireless communication, such as via near-field communication systems, or the like. The credential item may allow the user to identify themselves to various components within the system (e.g., kiosks, an assigned vehicle), and may be used by the transportation system to initiate certain actions in response to a scan or other identification of the credential card (e.g., to cause vehicle doors to be opened when the user arrives, close the vehicle doors when the user has boarded, etc.).

After a destination is selected, the user may be prompted to provide payment for the ride. Payment may be provided via a payment account that is associated with the user, or directly via the kiosk (e.g., via payment card, cash, digital wallets, wireless payment devices, etc.). After a trip has been requested and the user has paid, the system will associate the trip with the user within the system. The system may also assign a parking spot (which may also be referred to as a boarding slot) to the trip and cause the identifier of the boarding slot to be displayed to the user (e.g., on the kiosk, on a user's device, etc.).

Once the user arrives at the assigned boarding slot, the user may identify themself to a waiting vehicle, such as by scanning a credential item, ticket, or the like. Upon determining that the user has arrived for the trip for which they are associated (and that is associated with that boarding slot and/or vehicle), the vehicle doors may open and the trip may be initiated.

Kiosks may also be used to modify or cancel a ride. For example, the user may scan their credential card, device, ticket, etc., at a kiosk, and make changes directly via the user interface. In some cases, the system may assign a different boarding slot to the modified trip request, and inform the user of the new boarding slot.

Rides may also be requested, modified, and otherwise managed via an application on a device, such as a mobile phone, smart watch, etc. The process may be substantially similar to that provided by the kiosk. The application may also provide access to customer support, tutorials, instructions, and the like. As noted herein, a user's mobile phone or other electronic device may be used as a credential item. Thus, a user can execute an entire ride using their mobile phone to request a ride, pay for the ride, confirm details of the ride, identify themselves to the vehicle and/or other system components, and the like.

Once a user is in a vehicle for their ride, they may initiate a door closing operation. Once initiated, the vehicle may provide an indication that the doors are closing (e.g., an audio and/or visual indication), optionally including a countdown to the door closure. The user may pause the door closure at any time (e.g., via a vehicle or device user interface), or otherwise request that the doors reopen.

Once the doors are closed, the vehicle may initiate the trip, including indicating to the system (e.g., the boarding zone router) that it is prepared for departure. Once the vehicle's trajectory through the boarding zone is deconflicted, as described herein, the vehicle may depart the boarding zone to complete the trip. (In some cases, the vehicle's path and/or trajectory may be determined, or the operation of determining the vehicle's path and/or trajectory may be initiated, in response to a user indicating that they are ready to depart.) During the ride, a progress bar or other trip progress information (e.g., a moving indication on a map of the roadway system) may be displayed to the user, via the vehicle's user interface and/or on the user's device. During the ride, the user may access customer support via the vehicle or their mobile phone or other device.

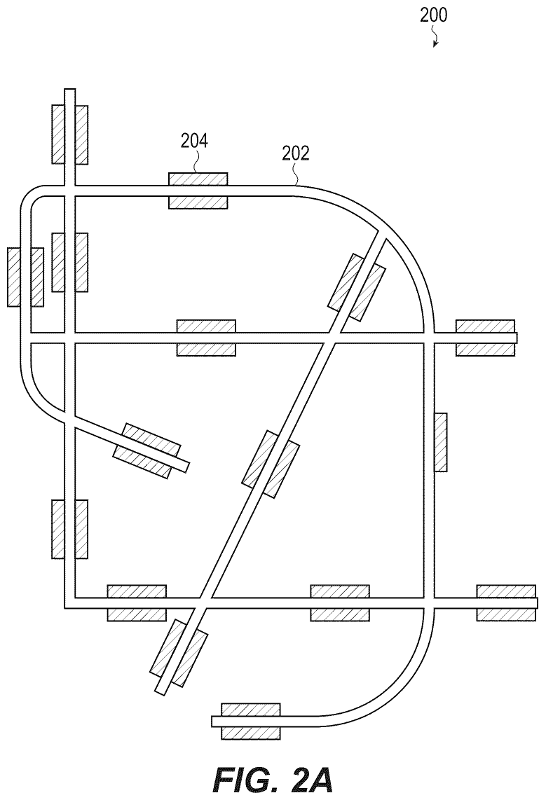

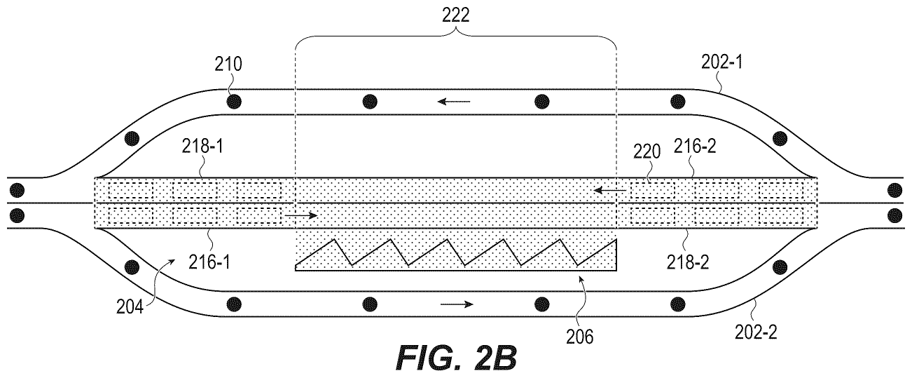

FIG. 2A illustrates an example overview of a roadway system 200 of the transportation system 110. The roadway system 200 may include trunk lanes, such as trunk lane 202, and boarding zones, such as boarding zone 204. Trunk lanes may be configured for continuous vehicle flow, and may be associated with a moving position-target control scheme for defining the motions and positions of vehicles on the trunk lanes. Trunk lanes may be configured for continuous traffic flow, and may include one or more traffic lanes. Traffic lanes for travel in opposite directions may be physically separated (e.g., separated by barricades, walls, fences, etc.). In cases where multiple traffic lanes are configured for traffic in a same direction, the multiple traffic lanes may be physically separated or contiguous. Each trunk lane, or segment of a trunk lane, may be under the control authority of a trunk router 105. Where trunk lanes are shown as intersecting in FIG. 2A, the trunk lanes may join at an intersection where vehicles may cross the traffic lanes of other trunk lanes. In other cases, the trunk lanes may be separated (e.g., one trunk lane may pass under another trunk lane).

The boarding zones may include boarding slots that are configured to receive autonomous vehicles 108. The boarding slots may provide a parking location for the autonomous vehicles 108 where passengers can enter and exit the vehicles. Boarding zones may be configured for convenient access by passengers. For example, boarding zones may be positioned at grade level, and boarding platforms may be at the same height as the vehicle floor. The boarding zones may also include input and output buffer zones where vehicles attempting to enter and exit the boarding zone may pause while the associated boarding zone router deconflicts their trajectories and ensures safe transit through the boarding zone. Input and output buffer zones may include predefined input and output buffer positions where vehicles may pause.

The roadway system 200 may be separate from conventional vehicle traffic, and may in some cases have no intersections with roads that are accessible by conventional vehicle traffic. In some cases, this may be achieved by vertically separating portions of the roadway system 200 from conventional roads, such that conventional vehicles do not have vehicular access to the roadway system 200.

FIG. 2B illustrates an example portion of a trunk lane 202 and a boarding zone 204 that is accessible via the trunk lane 202. Arrows in FIG. 2B indicate the direction of traffic flow along various regions, segments, or portions of the trunk lane 202 and boarding zone 204. The trunk lane 202 may include a first lane 202-1 for travel in a first direction, and a second lane 202-2 for travel in a second (e.g., opposite) direction.

The boarding zone 204 includes a set of parking spots 206 configured to receive autonomous vehicles. The parking spots 206 (or boarding slots) may also allow passenger access to the vehicles to facilitate boarding and exiting vehicles. The boarding zone 204 may be at grade level, as described herein, and may provide convenient grade-level access for passengers.

The boarding zone 204 also includes buffer zones 216, 218. The buffer zones include input buffer zones 216-1, 216-2, where vehicles may pause when transitioning from the trunk lane 202 to the boarding zone 204, and output buffer zones 218-1, 218-2 where vehicles may pause when transitioning from the boarding zone 204 to a trunk lane. Buffer zones 216, 218 may include buffer positions (e.g., buffer position 220) which are predefined positions in the buffer zones where vehicles may pause. As described herein, a boarding zone router may instruct vehicles to pause at a particular buffer position when entering/exiting a boarding zone.

The boarding zone 204 also includes a vehicle mixing zone 222 adjacent to the set of parking spots 206. The vehicle mixing zone 222 may be configured to allow vehicle access to the set of parking spots 206 for vehicles from either lane of the trunk lane 202. More particularly, as described herein, the mixing zone 222 may include a first mixing lane connected to the first roadway and a second mixing lane connected to the second roadway. The mixing lanes may be road segments that are configured to receive traffic traveling in a given direction, but which allow vehicles to travel in multiple directions to facilitate arrival and departure maneuvers (as defined by arrival and departure trajectories).

A boarding zone 204, and more particularly, a mixing zone 222, is one of the limited locations within the transportation system where vehicles may travel in multiple directions and/or cross paths. Accordingly, boarding zones may employ a different deconfliction technique, as compared to trunk lanes, to maintain safe separation between vehicles. For example, FIG. 2B illustrates example moving position-targets 210 of the trunk lane 202, representing valid positions for vehicles along the trunk lane 202. The boarding zone 204, on the other hand, defines an area (indicated by stippling) where a trajectory comparison technique is used to deconflict vehicle trajectories instead of moving position-targets 210.

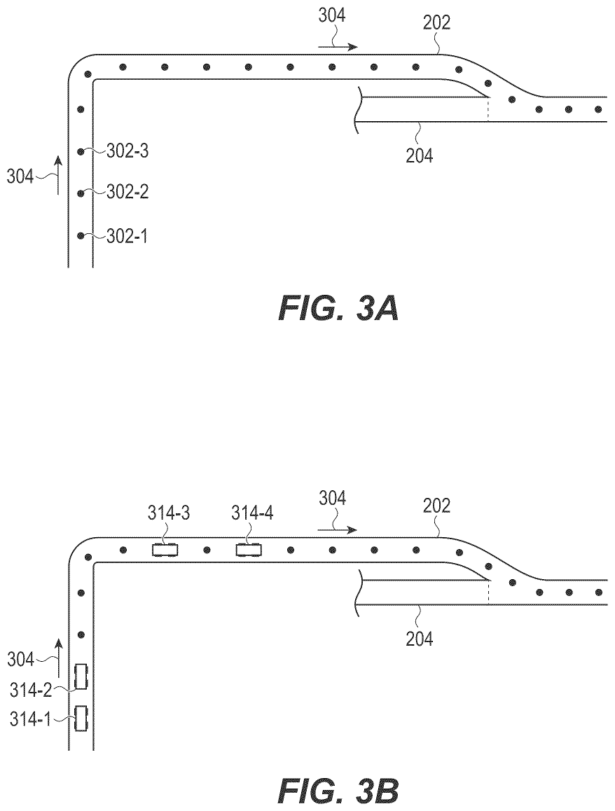

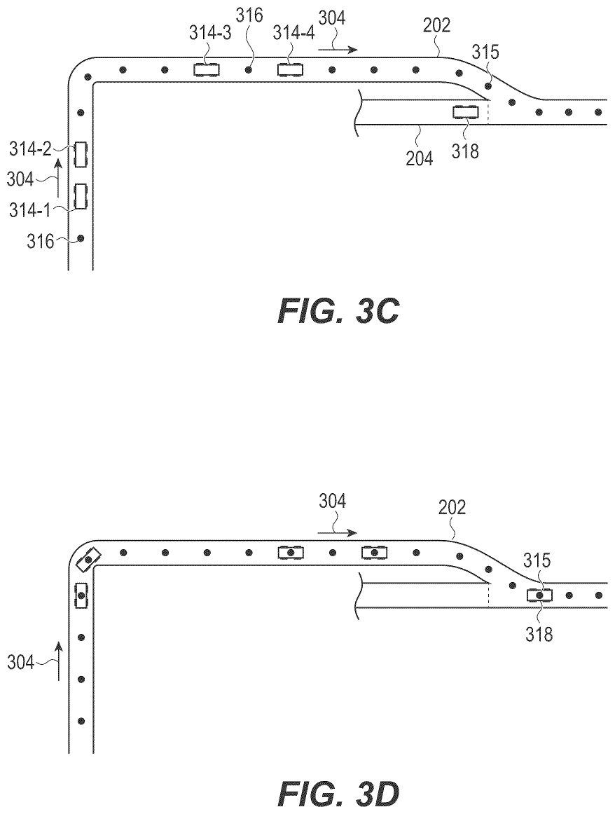

FIGS. 3A-3D illustrate an example portion of the trunk lane 202 and a boarding zone 204, illustrating features of the moving position-target control scheme, and how vehicles may enter the trunk lane 202 from a boarding zone 204.

With reference to FIG. 3A, in a moving position-target control scheme, vehicles on the trunk lane 202 are configured to follow moving position-targets 302 (e.g., 302-1, . . . , 302-n) that move, virtually, along the trunk lane 202. For example, the moving position-targets 302 (also referred to herein simply as position targets) may be conceptualized as virtual points that move along the trunk lane 202 and that the vehicles will attempt to remain “on” as they navigate along the trunk lane. In this way, the manner in which the moving position-targets 302 (and thus the vehicles) move along the trunk lane may be predefined for the trunk lane, and any vehicle that drives along the trunk lane in accordance with the moving position-target control scheme will move in a predictable, predetermined manner (e.g., at a position, velocity, acceleration, etc., that is predefined by the moving position-targets). As shown in FIG. 3A, the positions targets 302 move along a direction indicated by arrows 304. Moving position-targets may be predefined (e.g., by trunk routers) for the roadway, and may be defined regardless of whether a vehicle is occupying or following them.

As described herein, the position targets need not have a fixed speed or fixed separation distance along a trunk lane. Rather, such parameters may vary to accommodate various needs of the transportation system. For example, the velocity of the position targets may change (e.g., decrease) around a turn in the trunk lane, and the distance between the position targets may also change (e.g., decrease) around the turn. Even where speeds and/or following distances change in a moving position-target control scheme, the flow rate of vehicles may remain constant along the trunk lane, thus enabling steady-state operation of the system and avoiding backups or other non-steady state conditions.

The position targets 302 may be defined in any suitable manner. For example, the position targets 302 may be defined by functions that define position, velocity, and acceleration along the trunk lane as a function of time. Each vehicle may be provided with (or generate based on other information) a representation (e.g., a parametric representation, a function) of its assigned moving position-target 302 so that each vehicle can independently attempt to maintain the position, velocity, and acceleration values defined by the function. Thus, for example, a vehicle may follow a position target by using the particular parametric representation (or other function defining position, velocity, and acceleration with respect to time) that is provided to and/or generated by the vehicle. As used herein, assigning a moving position-target to a vehicle may include (or result in) a vehicle being provided with the representation of the moving position-target, and/or information from which a representation of the moving position-target may be generated.

As used herein, a vehicle “following” a position target refers to the vehicle attempting to maintain its position at the virtual position target (or at a fixed offset from the virtual position target), and does not require that the vehicle be behind the virtual position target. For example, a vehicle may “follow” the position target by using closed-loop controllers that control the steering and propulsion systems of the vehicle to minimize an error between the vehicle's actual position, velocity, and acceleration and the prescribed position, velocity, and acceleration (as defined by a parametric representation, for example). As would be expected in a closed-loop control system, the actual motion parameters of the vehicle may deviate slightly from the prescribed parameters, and as such the actual motion parameters may not be exactly equal to the prescribed parameters during normal operations of the system. Thus, following, tracking, or otherwise maintaining coincidence with a position target will be understood to include the potential of such incidental errors.

FIG. 3B illustrates the portion of the trunk lane 202 at a time to in which vehicles 314-1, 314-2, 314-3, and 314-4 are travelling along the trunk lane 202. As shown in FIG. 3B, each vehicle is coincident with a respective position target (e.g., the vehicle 314-1 is coincident with the position target 302-1, the vehicle 314-2 is coincident with the position target 302-2). The vehicles may be configured to follow their respective position targets as the position targets move along the trunk lane 202 in the direction 304. For example, as described above, the vehicles 314 may implement a closed-loop control scheme in which the position, velocity, and acceleration of the position targets 302 are used as position, speed, and acceleration setpoints for the vehicles, and the vehicles 314 follow the position targets 302 by attempting to minimize or reduce the error between the position targets and the actual position of the vehicle.

FIG. 3C illustrates the portion of the trunk lane 202 at a time ti in which vehicles 314-1, 314-2, 314-3, and 314-4 have advanced along the trunk lane 202 in accordance with the movement of the position targets. For example, the vehicle 314-1 has advanced in concert with the position target 302-1. FIG. 3C also illustrates a new position target 316, representing the position target that is immediately behind the position target 302-1 (which is shown in FIG. 3A and is occupied by vehicle 314-1). Notably, because the vehicles are following the position targets, they do not converge on one another as they travel along the trunk lane 202. For example, the available vehicle position between the vehicles 314-3 and 314-4 (position target 302-4) remains available and unoccupied as the vehicles navigate along the trunk lane 202 (e.g., the trailing vehicle 314-3 does not attempt to catch up to the leading vehicle 314-4, but instead remains coincident with its associated position target). In some cases, as described herein, vehicles may be instructed to shift or change their position target while traversing a trunk lane, such as to make space for a vehicle departing a boarding zone.

FIG. 3C also shows a vehicle 318 that is exiting the boarding zone 204 and joining the trunk lane 202. As described herein, the boarding zone may not employ a moving position-target control scheme, and instead may be provided with a trajectory segment by the associated boarding zone router after the boarding zone router deconflicts the trajectory segment. As described herein, the boarding zone router may also request a position target reservation from a trunk lane router. For example, the trunk lane router may have reserved the position target 315 for the vehicle 318, and the boarding zone router may have provided a trajectory to the vehicle 318 that will cause the vehicle 318 to traverse the boarding zone, approach the position target 315, and synchronize its travel with the position target 315, as shown in FIG. 3D.

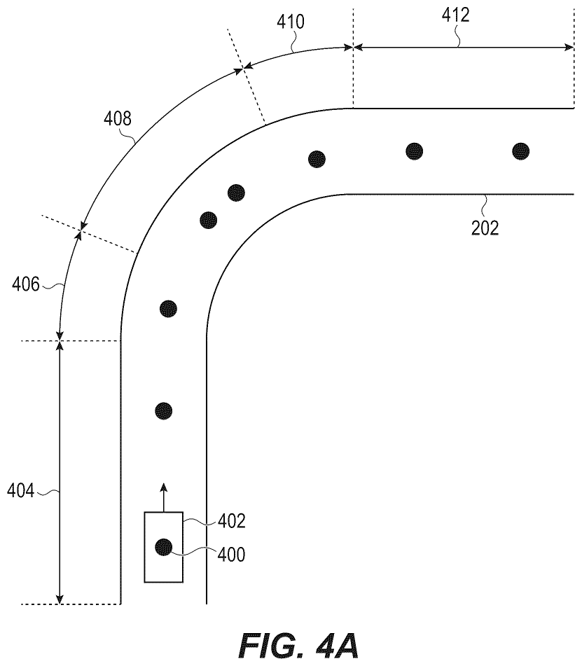

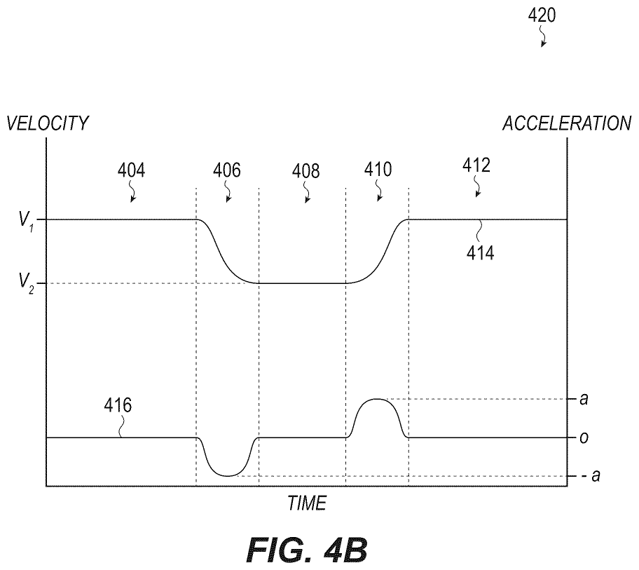

FIG. 4A illustrates vehicles traversing a roadway using a moving position-target scheme, and FIG. 4B illustrates example velocity and acceleration functions that define a vehicle's trajectory as it follows a moving position-target. FIG. 4A illustrates a portion of the trunk lane 202, and a vehicle 402 that is assigned to and following the position target 400. The moving position-target scheme for this section of the trunk lane may be configured so that vehicles decelerate as they approach a turn, execute the turn at a reduced speed, and then accelerate after the turn. As shown in FIG. 4A, the moving position-target scheme for this segment of the trunk lane may include a first constant speed segment 404, a deceleration segment 406, a second constant speed segment 408, an acceleration segment 410, and a third constant speed segment 412.

FIG. 4B illustrates an example plot 420 of velocity and acceleration setpoints, for a moving position-target along the segment of the trunk lane 202 in FIG. 4A, with respect to time. The plot 420 illustrates an example acceleration profile 416 showing the deceleration (at rate-a) during the deceleration segment 406 and the acceleration (at rate a) during the acceleration segment 410. The plot 420 also illustrates an example velocity profile 414, showing the velocity changes during the deceleration segment 406 and the acceleration segment 410 as a result of the deceleration and acceleration. During the constant speed segments 404, 408, and 412 the velocity remains constant, and the acceleration remains at zero. As described herein, the vehicle 402 may be configured to track these velocity and acceleration setpoints to traverse the trunk lane. Additionally, the vehicle may track a position setpoint, which may be represented in cartesian or other spatial coordinates. As described herein, the vehicle may use closed-loop feedback control systems to control its propulsion, braking, and/or steering systems to attempt to maintain coincidence with (e.g., track) the velocity and acceleration setpoints of the assigned moving position-target (e.g., the assigned trajectory).

In some cases, the information for determining the position, velocity, and acceleration setpoints is provided to a vehicle from a boarding zone router or other system router. Thus, for example, a vehicle controller may generate and/or determine its setpoints using a parametric representation (or any other function, set of functions, or information from which the setpoints can be determined) provided to it from a boarding zone router.

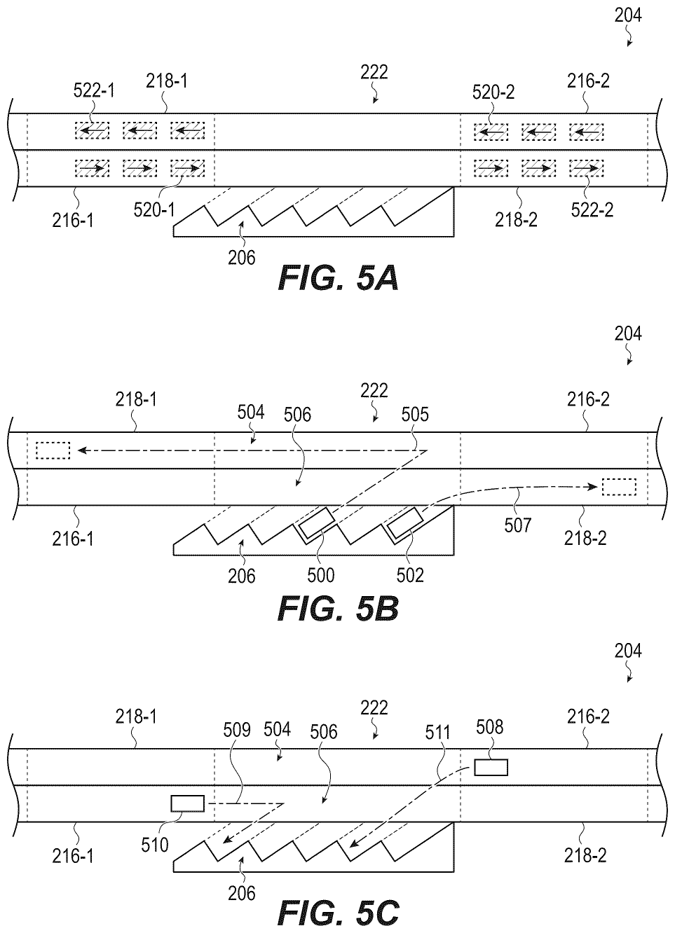

FIGS. 5A-5C illustrate example boarding zone operations, and in particular, example types of vehicle maneuvers and trajectories that may be used by vehicles in a boarding zone. FIG. 5A illustrates the boarding zone 204, which includes buffer zones 216, 218 (e.g., input buffer zones 216-1, 216-2, where vehicles may pause when transitioning from the trunk lane to the boarding zone 204, and output buffer zones 218-1, 218-2 where vehicles may pause when transitioning from the boarding zone to a trunk lane). Buffer zones may include buffer positions 520, 522, which are predefined positions in the buffer zones where vehicles may pause during entry to or exit from the boarding zone. The buffer positions include input buffer positions 520 (where vehicles may pause when entering the boarding zone from a trunk lane) and output buffer positions 522 (where vehicles may pause when exiting the boarding zone). The boarding zone 204 also includes parking spots 206 where vehicles can park during boarding operations (e.g., loading and unloading passengers, freight, etc.).

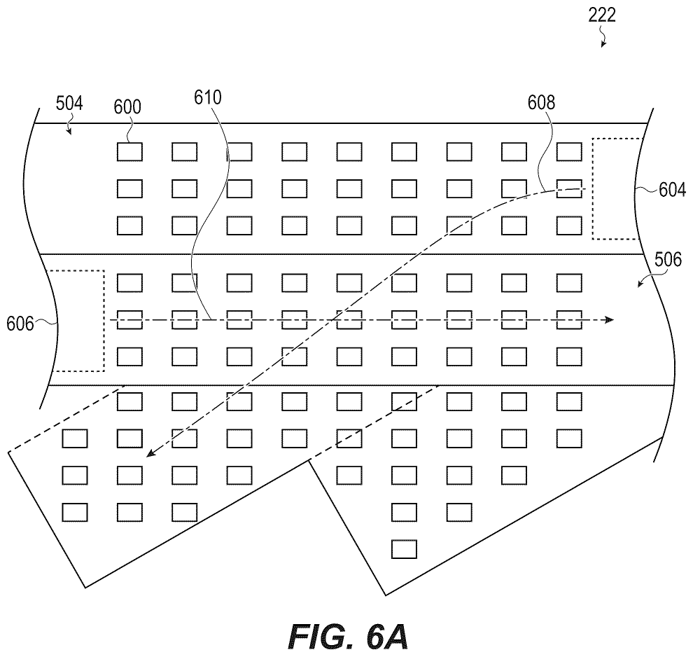

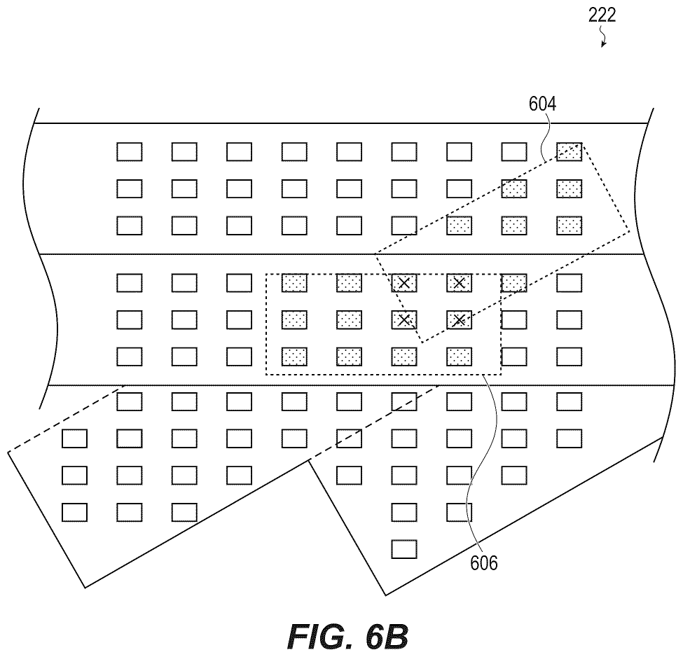

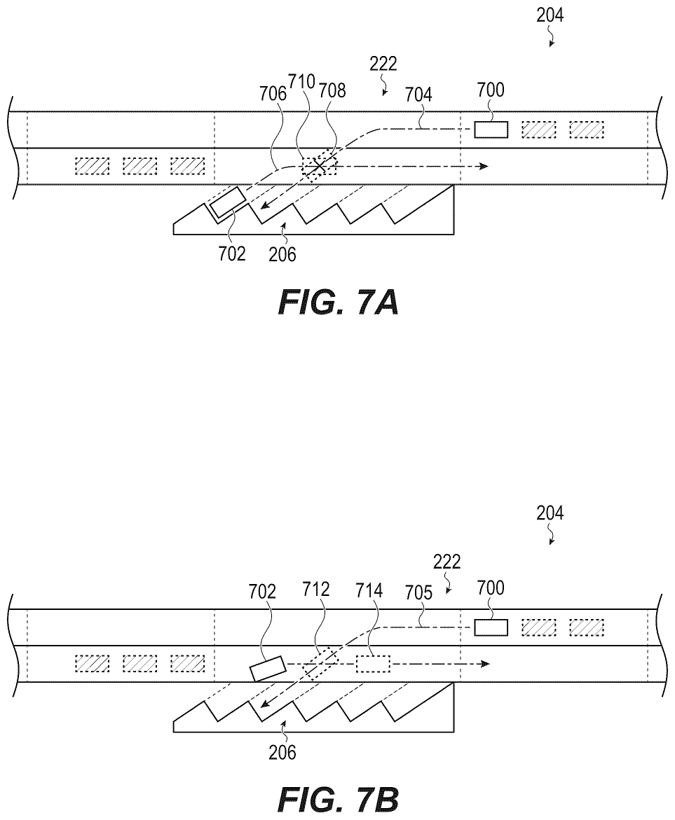

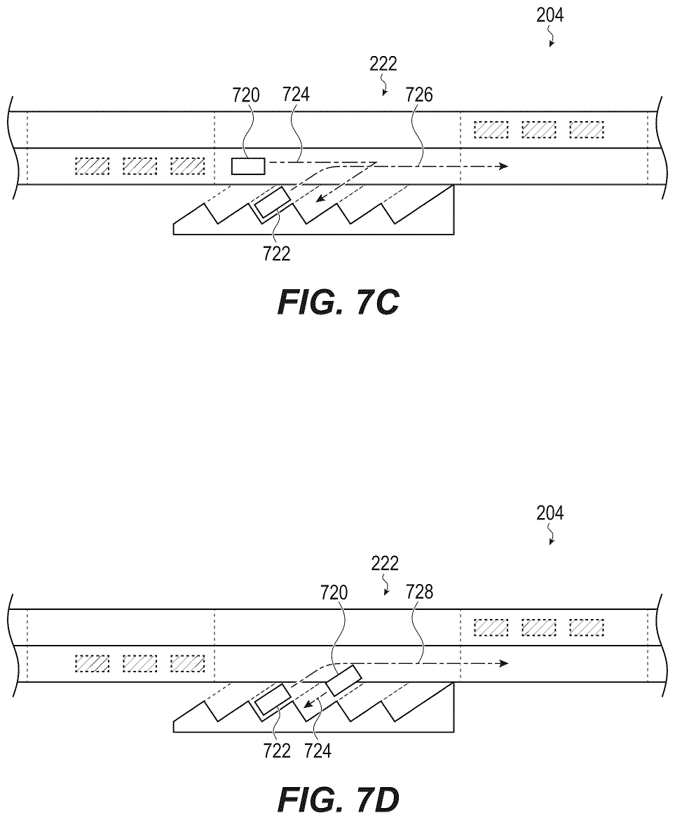

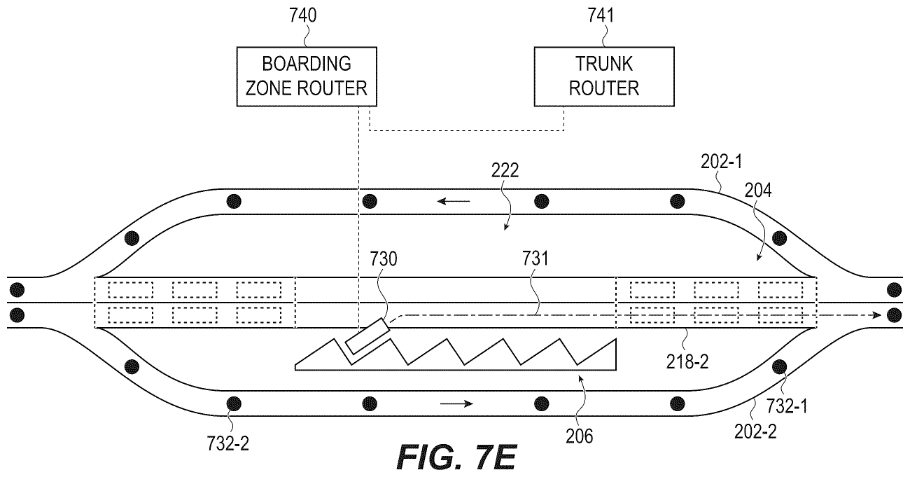

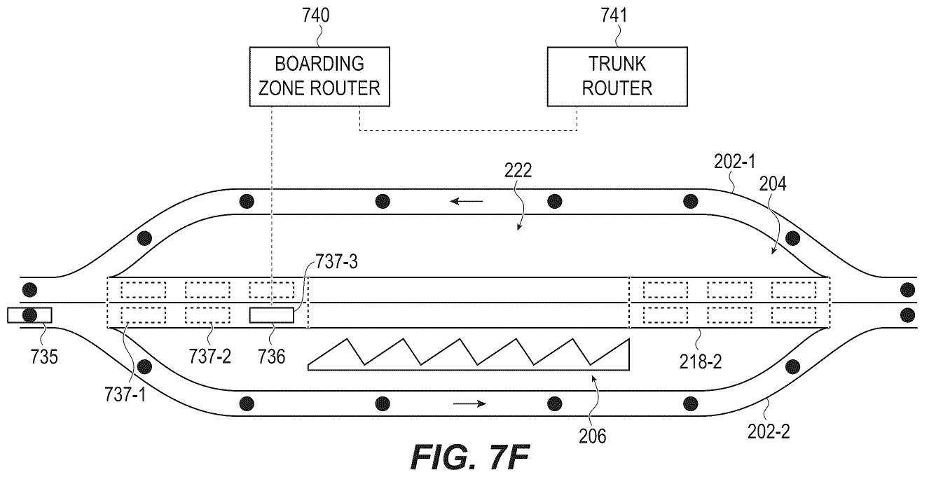

FIG. 5B illustrates example maneuvers for vehicles 500, 502 exiting the boarding zone 204. For example, the vehicles 500, 502 are positioned in respective parking spots 206. The vehicles may be associated with respective trip requests for which respective paths have been determined. When a vehicle is ready to depart (e.g., the doors are closed and the passenger has indicated that they are prepared to depart), the vehicle may provide an indication to a boarding zone router for the boarding zone 204 that the vehicle is prepared to depart. In response to the indication, the boarding zone router may determine when the vehicle can depart safely (as described herein with respect to FIGS. 6A-7D), and may generate and provide the vehicle with a trajectory for its trip and instruct the vehicle to begin traversing the trajectory. The trajectory may include a trajectory segment that extends from the vehicle's parking spot to the trunk lane (and/or to or through an output buffer position of the boarding zone 204). Thus, for example, the boarding zone router may provide the vehicles 500, 502 trajectory segments 505, 507, respectively. The trajectory segment 505 illustrates an example in which the vehicle 500 needs to cross a lane 506 (which is also used by vehicles travelling in an opposite direction) in order to arrive in the lane 504 where it will travel along the trunk lane. The trajectory segment 507 illustrates an example in which the vehicle 502 does not need to cross a lane of traffic in order to reach its trunk lane.

As described herein, vehicle trajectories may not be determined until the vehicle is ready to depart (e.g., the user has indicated that they are ready to depart, such as via a button in the vehicle, a graphical user interface of the vehicle or a mobile application, or the like). In particular, the transportation system described herein may operate in an on-demand manner. As such, it may be difficult to predict an exact trajectory for a vehicle at a future time, since the exact condition of the transportation system (e.g., available moving position-targets, etc.) is not known. Thus, by determining trajectories in response to an indication that the user is ready to depart, the present state of the system can be taken into consideration when determining the trajectory.

FIG. 5C illustrates example maneuvers for vehicles 508, 510 entering the boarding zone 204 from a trunk lane. For example, the vehicles 508, 510 are positioned in (or passing through) respective input buffer positions. The boarding zone router may determine and provide a trajectory segment from a vehicle's position to an assigned parking spot, and may provide the trajectory segment to the vehicle. The boarding zone router may also determine when the vehicle can safely travel along its trajectory segment, and instruct the vehicle to begin traversing the trajectory segment. Thus, for example, the boarding zone router may provide the vehicles 508, 510 trajectory segments 511, 509, respectively. The trajectory segment 511 illustrates an example in which the vehicle 508 needs to cross a lane 506 in order to arrive in its parking spot. The trajectory segment 509 illustrates an example in which the vehicle 510 does not need to cross a lane in order to reach its parking spot.

FIGS. 5B-5C illustrate example trajectory segments through the boarding zone. Because vehicles are crossing lanes and otherwise performing numerous vehicle maneuvers within a common area where vehicles are travelling along possibly intersecting trajectories (e.g., the mixing zone 222), greater safety can be achieved by selecting trajectories (and the times when those trajectories are to be initiated) that are predetermined to be safe (e.g., to lack collisions or other adverse encounters with other vehicles). FIGS. 6A-7D illustrate example techniques by which a boarding zone router (or other system module or service) may determine whether a given trajectory conflicts with other trajectories. Further, these figures illustrate how detecting a deconflicted trajectory may be used as a gating or triggering condition to determine when vehicles can begin to traverse their assigned trajectories.

FIGS. 6A-6B illustrate how vehicle trajectories may be evaluated in contested zones (e.g., the mixing zone 222) in order to determine whether they intersect or otherwise interfere with each other. While FIGS. 6A-6B illustrate deconfliction operations in a mixing zone 222 of a boarding zone, it will be understood that the same or similar operations may be used for deconfliction in any other contested zone, such as a contested intersection, a parking lot, parking garage, other regions of a boarding zone, traffic lanes that do not employ other deconfliction techniques, and the like.

As shown in FIG. 6A, vehicles 604, 606 may be associated with trajectories 608, 610, respectively, through the mixing zone 222. The trajectory 608 extends from the lane 504, across the lane 506, and into a parking spot, while the trajectory 610 extends along the lane 506. These are merely example trajectories, however, and the same or similar techniques described herein may be used to evaluate other trajectories through contested zones in the same or similar manner.

The mixing zone 222 may be associated with occupancy cells (e.g., cell 600), which correspond to fixed points in space. A boarding zone router (or other component of a control system of a transportation system) may be configured to determine the occupancy status of each cell for any given vehicle trajectory, and determine whether any cell would be occupied by more than one vehicle at a given time.

FIG. 6B illustrates an example point in time where the trajectories 608, 610 (FIG. 6A) intersect. The stippled occupancy cells represent the cells that are occupied by a vehicle at a given time during a trajectory. As shown in FIG. 6B, the trajectories 608, 610 of FIG. 6A cause the vehicles 604, 606 to occupy overlapping cells (represented by an inscribed x) at a given time. Stated another way, at least one of the occupancy cells in the contested zone is occupied by more than one vehicle at a given time, indicating that the vehicles would collide (or otherwise have an adverse encounter) if they traversed the trajectories 608, 610. Thus, the boarding zone router (or other component of the control system) may determine that the trajectories 608, 610 intersect.

As described herein, proposed trajectories may be compared to scheduled trajectories to determine whether the proposed trajectory can be safely traversed (e.g., they do not intersect or otherwise do not result in an adverse encounter). If so, a vehicle may be instructed to traverse the proposed trajectory, and if not, a second proposed trajectory (e.g., having the same spatial parameters but different temporal parameters) may be evaluated. As used herein, proposed trajectories may refer to trajectories that may be used for a vehicle if they can be deconflicted with respect to other trajectories, and scheduled trajectories may refer to trajectories that vehicles are already traversing and/or have been instructed to traverse.

In some cases, trajectories are deemed to intersect if they would result in an adverse encounter between vehicles. An adverse encounter includes collisions or other contact between vehicles, as well as near-misses or other situations where at least one of the vehicles would interfere with the safe or comfortable operation of another vehicle. Accordingly, in order to avoid such adverse encounters, the deconfliction operation may assume that the vehicles “occupy” a space (e.g., a vehicle envelope) larger than the exact physical dimensions of the vehicle. For example, each vehicle may occupy a vehicle envelope that includes a space buffer around the periphery of the vehicle. The size of the vehicle envelopes may be determined at least in part on certain parameters of the vehicles and the manner in which the vehicles are controlled. For example, the vehicle envelopes may be configured to avoid triggering braking events by nearby vehicles. As a specific example, a vehicle may be configured to initiate a braking event if it detects another vehicle within 10 feet in front of the vehicle. Accordingly, the vehicle envelopes may include at least a 5-foot buffer around the periphery of the vehicle. In this way, trajectories would be considered intersecting if they cause vehicles to come within 10 feet of each other, but would not be considered intersecting if the vehicles remain greater than 10 feet apart (and thus the trajectories could be safely traversed by the vehicles without risking unscheduled braking events). The foregoing values are merely examples, however, and other values and techniques for defining the vehicle envelopes are also considered, and may be selected based on various operational parameters of the portion of the transportation system being evaluated. For example, the size of the vehicle envelopes may depend at least in part on a speed associated with the trajectories.

A control system may select different vehicle envelopes for its deconfliction analysis depending on various factors. In some cases, different vehicle envelopes may be used based on an operational state of the system. For example, during a normal or nominal operating state, a standard envelope may be used. In an increased-safety state, the control system may select a larger vehicle envelope (e.g., larger than the standard vehicle envelope) to provide a greater amount of separation between vehicles. In an unoccupied state, where the vehicles subject to the deconfliction analysis are known to be unoccupied, the control system may select a smaller vehicle envelope (e.g., smaller than the standard vehicle envelope), and the like.

As described herein, trajectory deconfliction in contested zones may be used as a gating condition for initiating vehicle traversal of a contested zone. For example, a vehicle may only be instructed to traverse a contested zone in response to determining that its proposed trajectory will not cause it to contact other vehicles that are scheduled to traverse the contested zone at a same timeframe as the vehicle. FIGS. 7A-7D illustrate an example technique for controlling vehicle operations in a contested zone. While FIGS. 7A-7D describe the example operations with respect to a boarding zone, the same or similar technique will be understood to apply to other contested zones, such as trunk lane (or other roadway) intersections, parking garages, vehicle storage facilities, parking lots, and the like.

FIG. 7A illustrates the boarding zone 204 with a vehicle 700 positioned at an input buffer position of an input buffer to the boarding zone 204, as well as a vehicle 702 positioned in a parking spot of the boarding zone. In this example, the vehicle 700 is associated with a proposed trajectory segment 704, and the vehicle 702 is associated with a trajectory segment 706. At the time represented in FIG. 7A, the vehicle 702 has been instructed to traverse its trajectory segment 706 (e.g., the vehicle 702 is scheduled to traverse a portion of the boarding zone 204 using the trajectory segment 706), and the vehicle 700 has been instructed to pause at an input buffer location. The boarding zone router for the boarding zone 204 may select a parking spot for the vehicle 700 (e.g., a parking spot that is schedule to be unoccupied and is therefore available for the vehicle 700 to park) from a set of candidate parking spots, and may determine a proposed trajectory segment 704 from the input buffer position to the selected parking spot. The boarding zone router may determine whether the proposed trajectory segment will cause the vehicle 700 to contact other respective vehicles traversing other respective trajectory segments through the boarding zone 204. For example, in the scenario shown in FIG. 7A, the boarding zone router may determine whether the proposed trajectory segment 704 will intersect the scheduled trajectory segment 706 (e.g., using the techniques described with respect to FIGS. 6A-6B). As shown in FIG. 7A, the proposed trajectory segment 704 and the scheduled trajectory segment 706 intersect in the contested zone. More particularly, the trajectory segments result in the vehicle positions 708, 710, which overlap in space and time. While FIG. 7A illustrates actual contact between the vehicles, as described above, actual contact may be a sufficient but not necessary condition for a determination that vehicle trajectories intersect.

Because the proposed trajectory segment 704 intersects a scheduled trajectory, the boarding zone router may cause the vehicle 700 to delay departure from the input buffer position for at least a duration. After the duration (which may be a predetermined duration, one or more clock cycles of a processor or processing loop, or the like), a second proposed trajectory segment 705 may be determined for the vehicle, and the second proposed trajectory segment 705 may be evaluated for potential intersections with scheduled trajectories. In some cases, the second proposed trajectory segment 705 may be spatially identical to the first proposed trajectory segment 704, but have a different start time and therefore has different temporal properties. By delaying the departure of the vehicle 700 from the input buffer position, the vehicle that was already scheduled to traverse its trajectory segment will have traversed a portion of its trajectory segment, potentially resulting in a different deconfliction result for the trajectory segments. Thus, as shown in FIG. 7B, the deconfliction analysis begins at a time when the vehicle 702 has advanced to a new position, and thus the second proposed trajectory segment 705 does not intersect with the trajectory segment 706 (e.g., the vehicle 700 passes behind the vehicle 702, as represented by vehicle positions 712, 714.

When determining when a vehicle can depart an input buffer position and traverse its proposed trajectory segment, the boarding zone router may repeatedly perform the above-described operations until a proposed trajectory segment for a vehicle is determined not to intersect with a scheduled trajectory segment. Upon such determination, the boarding zone router instructs the vehicle to traverse its proposed trajectory segment. Once the vehicle has been instructed to traverse its proposed trajectory segment, its trajectory segment may be considered a scheduled or instructed trajectory segment that is then compared against other proposed trajectory segments to determine whether they can be safely traversed by other vehicles. By repeatedly or cyclically performing these operations, the boarding zone router can identify a first available safe time to initiate movement of a vehicle through a contested zone.

Similar operations as described with respect to FIGS. 7A-7B may be used to determine when a vehicle can safely depart a parking spot in order to traverse a contested zone of a boarding zone. For example, FIGS. 7C-7D illustrate the boarding zone 204 with a vehicle 720 that is traversing a scheduled trajectory segment 724 and a vehicle 722 that is in a parking spot and is prepared to depart the parking spot along a proposed trajectory segment 726 in order to join a trunk lane (e.g., to join a moving position-target on a trunk lane that was selected for the vehicle 722). FIG. 7C illustrates an example in which the scheduled trajectory segment 724 would intersect with the proposed trajectory segment 726. As such, departure of the vehicle 722 from its parking spot is delayed, and after a duration, the boarding zone router analyzes a second proposed trajectory segment to determine whether the second proposed trajectory segment is free of adverse encounters. FIG. 7D illustrates an example in which the vehicle 720 has traversed enough of its scheduled trajectory 724 that it no longer intersects with the proposed trajectory segment 726. Thus, in response to determining that the trajectories do not intersect, the boarding zone router instructs the vehicle 722 to depart the parking spot and traverse its second proposed trajectory segment 728.

While FIGS. 7A-7D illustrate examples in which one proposed trajectory segment is evaluated with respect to one scheduled trajectory segment, it will be understood that the same or similar operations may be performed for multiple trajectory segments. For example, there may be multiple trajectory segments that are scheduled in a contested zone, and multiple proposed trajectory segments for vehicles that are attempting to traverse the contested zone. In such cases, a proposed trajectory segment may be compared against each scheduled trajectory segment to determine when the associated vehicle can traverse its proposed trajectory segment.

In cases where multiple vehicles are waiting to traverse a contested zone, the boarding zone router may perform deconfliction operations for one vehicle at a time. For example, the boarding zone router may perform the deconfliction operations for a first vehicle (e.g., determining when that vehicle can traverse the contested zone and instruct it to initiate its traversal), and only move to deconfliction operations for a second vehicle after the first vehicle's traversal has been instructed and/or scheduled. In other cases, the boarding zone router may perform deconfliction operations for multiple vehicles in an overlapping or interlaced manner. For example, the boarding zone router may make one attempt to deconflict a proposed vehicle trajectory for a first vehicle attempting to traverse a contested zone, and if the proposed vehicle trajectory cannot be deconflicted, the boarding zone router may attempt to deconflict a proposed vehicle trajectory for a second vehicle attempting to traverse the contested zone. The boarding zone router may continue cycling through the waiting vehicles in turn and may cause each vehicle to initiate its travel when its proposed vehicle trajectory is deconflicted.

The same or similar deconfliction operations may also apply to platoons of vehicles. For example, where multiple vehicles are associated with similar trajectories through a contested zone, a router may group the vehicles into a platoon and may deconflict their trajectories as a group. In such cases, the platoon may be instructed to begin its traversal in response to a determination that each platoon vehicle's proposed trajectory through a contested zone does not intersect another scheduled trajectory. In some cases, the trajectory segments of a platoon are deconflicted by design (e.g., the trajectories of the vehicles in a platoon are preselected to be non-intersecting). In such cases, it may not be necessary to deconflict the platoon trajectories in a given platoon with respect to one another.

Vehicle platoons may be used for vehicles entering a boarding zone (e.g., travelling from an input buffer to a set of parking spots), and for vehicles departing a boarding zone (e.g., travelling from a set of parking spots to an output buffer or a trunk lane). Vehicle platoons may also be used in other contested zones, such as intersections, parking lots, parking garages, and the like.

As described with respect to FIGS. 7A-7D, any type of traversal of a contested zone may be gated by a deconfliction determination. Thus, for example, a vehicle arriving at the boarding zone may be instructed to traverse its trajectory through the boarding zone in response to determining that its trajectory does not intersect any other trajectories (e.g., the successful deconfliction is the trigger for instructing the vehicle to traverse the trajectory), and a vehicle preparing to depart a boarding zone may be instructed to traverse its trajectory through the boarding zone in response to determining that its trajectory does not intersect any other trajectories (e.g., the successful deconfliction is the trigger for instructing the vehicle to traverse the trajectory). In other cases, some traversals of a contested zone are not initiated until there are no other scheduled trajectories through the contested zone. For example, in some cases, vehicle arrival trajectories may be triggered in response to a successful deconfliction, while vehicle departures may only be initiated when all other departure and arrival trajectories have been completed and there are no other departure or arrival trajectories scheduled. In other cases, vehicle departure trajectories may be triggered in response to a successful deconfliction, while vehicle arrivals may only be initiated when all other departure and arrival trajectories have been completed and there are no other departure or arrival trajectories scheduled.

As described herein, a roadway system may use multiple deconfliction schemes at different regions in order to provide high throughput and system efficiency while maintaining safety standards. For example, boarding zones may employ trajectory comparison deconfliction schemes, as described with respect to FIGS. 6A-7D, while trunk lanes may employ a moving position-target deconfliction scheme, in which all moving position-targets on the trunk lane are defined to be non-conflicting with each other. The control system for a transportation system may therefore be configured to route vehicles in the system using both schemes in a manner that provides smooth, seamless, and efficient transfer of responsibility between the deconfliction schemes. FIGS. 7E-7F illustrate example operations by which vehicles are routed through the system using both deconfliction schemes.

FIG. 7E illustrates an example departure operation for a vehicle 730 in a parking spot 206 of a boarding zone 204. The boarding zone 204 may be connected to trunk lanes 202-1, 202-2. As shown in FIG. 7E, a control system (e.g., the control system 101) may receive a trip request, from a user, specifying an origin boarding zone 204 and a destination boarding zone. In response, the control system may select a vehicle for the trip request (e.g., the vehicle 730) from a set of candidate vehicles, and may determine a path for the trip request. The set of candidate vehicles may be a set of vehicles that are located at the origin boarding zone or are scheduled to be at the origin boarding zone at or near (e.g., before) the start time of the trip request. The path may extend from the origin boarding zone 204, along at least a portion of a trunk lane 202-2 of the roadway system, to the destination boarding zone. As described herein, the trunk lane 202-2 is associated with a set of candidate moving position-targets (moving position-targets 732 in FIG. 7E) defining vehicle position with respect to time along the trunk lane 202-2. The control system may assign the trip request to the vehicle, and may inform the user of the selected vehicle and the parking spot at which the selected vehicle can be accessed.

Once the vehicle is ready to depart (e.g., after the vehicle indicates that its doors are closed and the user has indicated they are prepared to depart), the boarding zone router 740 may determine, based at least in part on a location of a parking spot where the vehicle 730 is parked in the origin boarding zone, an estimated transit time of the vehicle from the parking spot to an entrance to the trunk lane (e.g., based on the trajectory segment 731, which corresponds to at least a portion of the path that was determined for the vehicle 730). The boarding zone router 740 and/or the trunk router 741 may select, based at least in part on the estimated transit duration, a moving position-target from the set of candidate moving position-targets 732 that the vehicle can reach based on its estimated transit time. Thus, as shown, the moving position-target 732-1 may not be reachable by the vehicle 730 based on the estimated transit time, but the moving position-target 732-2 may be reachable. For example, the selected moving position-target 732-2 may be configured to pass the origin boarding zone after the vehicle 730 arrives (or is able to arrive) at the entrance to the trunk lane 202-2 (e.g., where the output buffer 218-2 meets the trunk lane 202-2).

The estimated transit time may be based at least in part on a maximum allowable speed through the boarding zone (e.g., as established by system rules, local laws or regulations, passenger comfort, safety considerations, vehicle properties, or the like). In some cases, the moving position-target is selected based additionally on trajectory deconfliction results from the boarding zone router 740. The estimated transit time and trajectory deconfliction results allow the router(s) to select a moving position-target that the vehicle is capable of reaching without exceeding maximum speed or other trajectory limitations.

The trunk router 741 may select a moving position-target that is otherwise unassigned or available along the entire length of the trunk lane that the vehicle needs to traverse according to its path. By selecting such a moving position-target, the vehicle's trajectory is fully deconflicted at least to the next phase of its trip. More particularly, the boarding zone router 740 may provide a deconflicted trajectory for the vehicle that will terminate at an outermost input buffer position of a next boarding zone (or intersection or other contested zone) of its trip. Thus, for example, if the path determined by the control system for a trip extends from an origin boarding zone and along a single trunk lane to a destination boarding zone, the boarding zone router for the origin boarding zone will provide a deconflicted trajectory that extends from the initial parking spot to the outermost input buffer position at the destination boarding zone. The destination boarding zone may then assume responsibility for providing the remaining deconflicted trajectory segments to the vehicle for transit through the destination boarding zone. As another example, if the path extends from an origin boarding zone to an intermediate boarding zone or intersection, before continuing along another trunk lane to the final destination boarding zone, the origin boarding zone router may provide a deconflicted trajectory to the outermost input buffer position at the intermediate boarding zone or intersection, at which time the router responsible for the intermediate boarding zone or intersection will (in conjunction with other trunk routers) provide the next deconflicted trajectory segments for the vehicle, including next moving position-targets, deconflicted trajectories through contested zones, and the like.

Once a deconflicted trajectory to the input buffer position at the next boarding zone along a path is determined, the boarding zone router 740 may cause the vehicle 730 to travel from the parking spot to the trunk lane 202-2, merge into the trunk lane at the selected moving position-target 732-2, and travel along the portion of the trunk lane 202-2 by following the selected moving position-target 732-2. For example, the boarding zone router 740 may use the techniques described with respect to FIGS. 6A-6B and 7C-7D to perform such operations. For example, the boarding zone router 740 may determine a proposed trajectory segment for the vehicle, and cause the vehicle to traverse the proposed trajectory segment to travel from the parking spot to the trunk lane.

The proposed trajectory segment from a parking spot to a moving position-target may be configured to account for the particular timing of the selected moving position-target. Thus, for example, when determining the proposed trajectory segment through the boarding zone, the boarding zone router 740 may incorporate acceleration rates, velocities, departure times, pauses, and the like, that result in the vehicle meeting the selected moving position-target at the position, velocity, and acceleration, of the moving position-target (e.g., synchronizing arrival of the vehicle and the moving position-target). In some cases, this may result in a trajectory segment that does not depart the parking spot immediately, or does not follow a constant speed. For example, in some cases, the departure of the vehicle may be delayed by a delay duration based at least in part on a time when the selected moving position-target is configured to pass the boarding zone. This may avoid the situation where vehicles would need to travel through a boarding zone or other contested zone below a speed threshold, or need to pause at an output buffer position while waiting for the selected moving position-target to arrive. In other cases, the trajectory may include a pause at an output buffer position, or acceleration/deceleration operations in order to synchronize the arrival of the vehicle and the selected moving position-target.

In some cases, the trajectory segments for an exiting vehicle may include a pause or delay at an output buffer position. In such cases, the boarding zone router 740 may provide further trajectory segments to the vehicle to cause the vehicle to advance through the output buffer positions and ultimately depart from the farthest downstream output buffer position to synchronize with the assigned moving position-target.

FIG. 7F illustrates an example operation for a vehicle 735 arriving at the boarding zone 204, which may be a final destination for the trip assigned to the vehicle 735 or an intermediate destination. As described above, the vehicle 735 may be travelling along an initial path that terminates at an outermost input buffer position 737-1 of a set of input buffer positions 737 at the boarding zone. The boarding zone router 740 may detect an upcoming arrival of the vehicle 735. For example, the boarding zone router 740 may communicate with the trunk router 741 (which manages the trunk lane 202-2), which informs the boarding zone router 740 of the upcoming arrival of the vehicle 735. As other examples, the vehicle 735 may send a signal to the boarding zone router 740 indicating its upcoming arrival, and/or system sensors may detect the presence of the vehicle 735 and inform the boarding zone router 740 of its upcoming arrival.

In response to detecting the upcoming arrival of the vehicle, the boarding zone router 740 may select a parking spot from a set of candidate parking spots, at the destination boarding zone, for the vehicle, where the parking spot is scheduled to be unoccupied at a time of arrival of the vehicle at the parking spot.

In some cases, the boarding zone router 740 may change the target buffer position for the vehicle 735 depending on various factors. For example, in accordance with a determination that a downstream input buffer position 737 of the set of input buffer positions is scheduled to be unoccupied at a time of arrival of the vehicle at the destination boarding zone, the boarding zone router 740 may send an updated trajectory segment to the vehicle, the updated trajectory segment extending the initial path to the downstream input buffer position and including a path segment extending from the downstream input buffer position to the parking spot. For example, as shown in FIG. 7F, the downstream input buffer position 737-2 may be unoccupied when the vehicle 735 is scheduled to arrive. As such, the boarding zone router 740 may provide an updated trajectory segment that causes the vehicle 735 to travel to the downstream input buffer 737-2 (e.g., extending the initial path to the downstream input buffer). In this example, the farther downstream input buffer position 737-3 is scheduled to be occupied by vehicle 736 when the vehicle 735 arrives, so that input buffer position is not available and the vehicle 735 is not routed to that position.

If, on the other hand, there are not any downstream input buffer positions that are scheduled to be unoccupied when the vehicle 735 arrives, the boarding zone router 740 may not provide updated trajectory information, but instead may confirm that the outermost input buffer position is available, and cause the vehicle 735 to continue to the outermost input buffer position.

In some cases, if the outermost input buffer position is occupied, the boarding zone router 740 may take remedial actions, such as instructing the vehicle 735 to travel to a different position, such as a runoff area outside of the traffic lanes, or otherwise instructing the vehicle to stop at a safe location away from other vehicles. In some cases, the boarding zone router 740 may reserve an unoccupied moving position-target along the trunk lane 202-2 so that the vehicle can continue along the trunk lane to another destination (assuming a moving position-target that is unoccupied along that entire path is available). If the boarding zone router 740 does not confirm that the outermost input buffer position is available (e.g., in the event of a communication interruption between the router and the vehicle), the vehicle 735 may raise an alarm or an error condition, and may take remedial actions, such as safely diverting to a runoff area or coming to a controlled stop safely away from other vehicles.

The boarding zone router 740 may advance vehicles through the buffer positions once downstream positions become available. Thus, for example, as the vehicles in the input and output buffers are instructed to leave the buffers (e.g., to merge with an assigned moving position-target or to traverse a trajectory segment through a contested zone), they may vacate the downstream buffer positions. Upon detecting a vacated downstream input buffer, the boarding zone router 740 may instruct upstream vehicles to advance downstream to the next unoccupied input buffer position. Once the vehicle 735 arrives at the farthest downstream input buffer position 737-3, the boarding zone router 740 may route the vehicle 735 through the boarding zone and to its parking spot as described with respect to FIGS. 7A-7B, for example.

While FIGS. 7A-7F describe examples in which vehicles may pause at buffer positions, in some cases vehicles are not instructed to pause at buffer positions. For example, vehicles may be routed through buffers without stopping (and optionally without slowing) if the buffer positions are not occupied and if the trajectory through the contested zone(s) can be deconflicted.

FIGS. 6A-7F describe example vehicle control operations when departing from and arriving to boarding zones. It will be understood that boarding zones are merely one example area in the transportation systems where such operations may be used. More generally, the same or similar operations may be used to provide deconflicted vehicle arrival and departure operations at other contested zones, such as intersections, parking lots, parking garages, service and repair facilities, and the like.

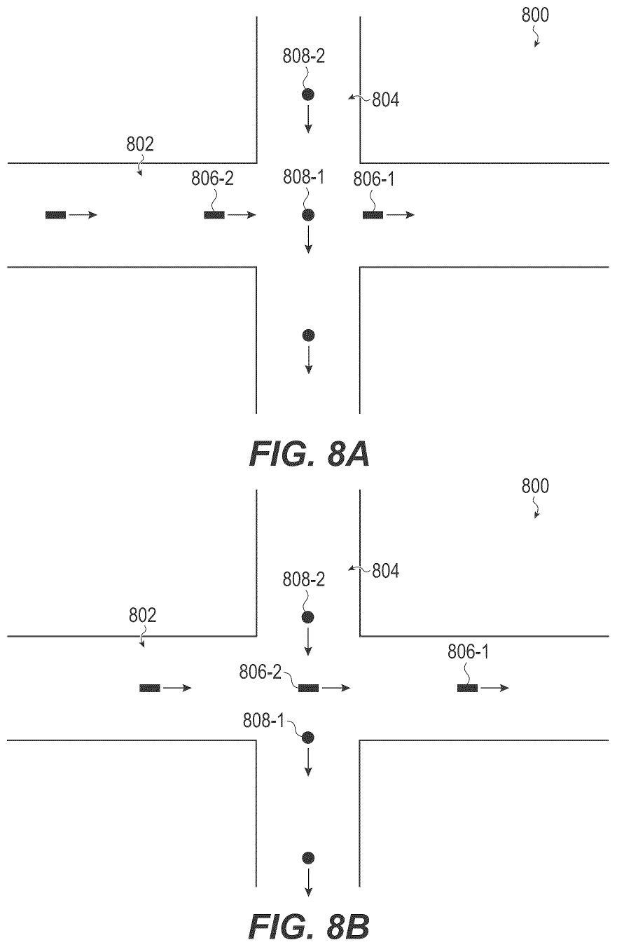

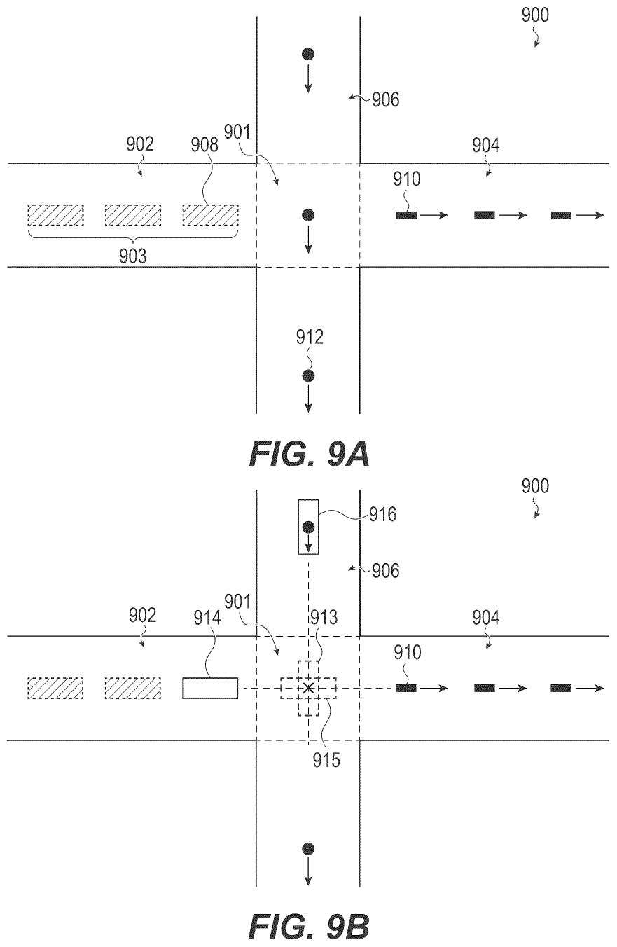

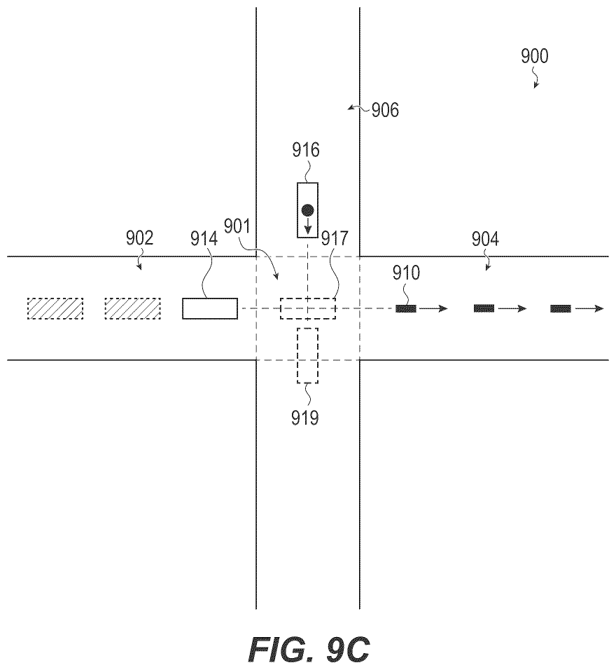

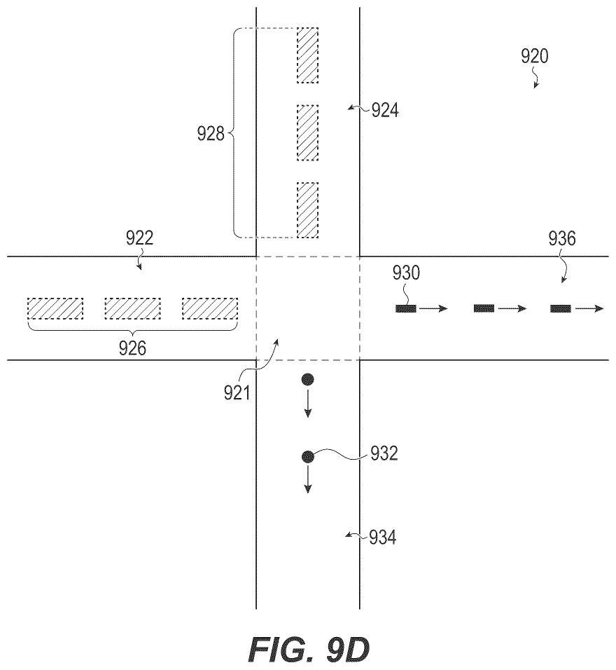

FIGS. 8A-9D illustrate example techniques for providing deconflicted trajectories through various types of intersections. FIGS. 8A-8B illustrate an example intersection 800 of two trunk lanes 802 and 804. As described herein, trunk lanes may be associated with moving position-targets that define position, velocity, and acceleration along the trunk lane as a function of time. Moreover, the moving position-targets on a trunk lane may be preconfigured to be nonconflicting. In the example intersection 800 shown in FIGS. 8A-8B, the moving position-targets 806, 808 of each trunk lane are interleaved or otherwise alternate through the intersection 800, such that vehicles associated with those targets will not interfere with each other. For example, FIG. 8A shows the trunk lanes where moving position-target 808-1 is in the intersection, while the moving position-targets 806-1, 806-2 on the intersecting trunk lane are outside the intersection. FIG. 8B illustrates the intersection 800 at a later time, when the moving position-targets have advanced, such that the moving position-targets 808-1, 808-2 are outside the intersection while the moving position-target 806-2 has advanced into the intersection. Alternating moving position-targets through an intersection as shown in FIGS. 8A-8B may be used so long as the moving position-targets maintain sufficient separation from one another to ensure vehicle safety and safe separation distances.

FIGS. 9A-9C illustrate an example intersection 900 where a trunk lane 902 intersects with a trunk lane 906. In this example, the trunk lane 906 uses a continuous flow of moving position-targets 912 through a contested zone 901 of the intersection. The trunk lane 902, however, terminates at the intersection at a buffer zone 903, and a new trunk lane segment 904 (with a separate set of moving position-targets 910) leads away from the intersection. In this example, vehicles travelling through the contested zone 901 on the trunk lane 902 may continue without pause. However, vehicles travelling on the trunk lane 902 are routed to and/or through the buffer zone 903 in the same or similar manner as a boarding zone. Intersections that use a buffer zone and trajectory deconfliction techniques may be associated with intersection routers, which may provide the same or similar functionalities as boarding zone routers with respect to routing vehicles from a buffer zone, through a contested zone, and onto a trunk lane (in synch with a moving position-target).

FIGS. 9B-9C illustrate an example deconfliction operation for the intersection 900. As shown in FIG. 9B, a vehicle 914 has arrived at the farthest downstream buffer position (e.g., position 908, FIG. 9A). The vehicle 914 may have been routed to the buffer position in the same or similar manner as described above with respect to the input buffers of boarding zones.

Once at the downstream buffer position, the intersection router may determine when the vehicle 914 can cross the intersection in the same or similar manner as a vehicle leaving a parking spot of a boarding zone. For example, the intersection router may (in conjunction with a trunk router associated with the trunk lane 904) select a moving position-target on the trunk lane 904, and may determine a proposed trajectory segment through the contested zone 901. The router may determine whether the proposed trajectory segment will intersect the trajectory of another vehicle that is travelling along the trunk lane 906 (e.g., the vehicle 916). If there is no conflict, the router may instruct the vehicle 914 to proceed, and if there is a conflict, the vehicle 914 will remain at the buffer position until an updated proposed trajectory is determined to be deconflicted. FIG. 9B illustrates an example scenario where the proposed trajectory for the vehicle 914 would intersect with the vehicle 916 (represented by future vehicle positions 913, 915). Accordingly, the intersection router would hold the vehicle 914 at the buffer position and reanalyze the traversal with an updated proposed trajectory. FIG. 9C illustrates the vehicles after a duration (e.g., one or more additional trajectory deconfliction cycles, a predefined duration, or the like). In this scenario, the proposed trajectory for the vehicle 914 does not intersect the vehicle 916 (represented by future vehicle positions 917, 919). Accordingly, the vehicle 914 will be instructed to traverse the updated proposed trajectory. As described with respect to the boarding zone operations, the proposed trajectories for the vehicle 914 are configured so that the vehicle will synchronize with the selected moving position-target 910 on the next trunk lane 904. Further, as described with respect to boarding zone operations, vehicles may be routed through buffer zones without stopping (and optionally without slowing) if the buffer positions are not occupied and if the trajectory through the contested zone can be deconflicted.

While FIGS. 9B-9C illustrate the vehicle 914 crossing through the intersection, a similar operation may be used if the path for the vehicle 914 continues on the trunk lane 906 (e.g., representing a turn from the trunk lane 902 onto the trunk lane 906). In such cases, the intersection router may reserve a moving position-target 912 (FIG. 9A) on the trunk lane 906 and may determine a proposed trajectory segment through the contested zone 901 that synchronizes the vehicle 914 with the selected moving position-target.

FIG. 9D illustrates an example intersection 920 where a trunk lane 922 intersects with a trunk lane 924, and both trunk lanes end at buffer zones 926, 928 proximate the intersection. Trunk lanes 934, 936 extend from the intersection, and vehicles from trunk lanes 922, 924 may reserve moving position-targets on either trunk lane 934, 936 (e.g., moving position-targets 932, 930, respectively), depending on the particular path with which they are associated. Vehicles travelling on the trunk lanes 922, 924 are routed to and/or through the buffer zones 926, 928 in the same or similar manner as a boarding zone.

Once a vehicle reaches the farthest downstream buffer position at a buffer zone 926, 928, the intersection router may determine when the vehicle can cross the intersection in the same or similar manner as a vehicle leaving a parking spot of a boarding zone. For example, the intersection router may select a moving position-target on the target trunk lane 934 or 936 (in conjunction with a trunk router associated with the target trunk lane), and may determine a proposed trajectory segment through the contested zone 921 that synchronizes the vehicle to the selected moving position-target. The router may determine whether the proposed trajectory segment will intersect the trajectory of another vehicle that is scheduled to travel through the contested zone 921. If there is no conflict, the router may instruct the vehicle to proceed, and if there is conflict, the vehicle will remain at the buffer position until an updated proposed trajectory is determined to be deconflicted. As described with respect to the boarding zone operations, the proposed trajectories for a vehicle traversing the intersection 920 are configured so that the vehicle will synchronize with the selected moving position target on the next trunk lane. Further, as described with respect to boarding zone operations, vehicles may be routed through buffers without stopping (and optionally without slowing) if the buffer positions are not occupied and if the trajectory through the contested zone can be deconflicted.

In some cases, a control system may change the manner in which trajectories are deconflicted through a given intersection. For example, the control system may select a deconfliction technique (e.g., the interleaved moving position-targets of FIGS. 8A-8B, the single buffer of FIGS. 9A-9C, or the dual buffer of FIG. 9D) for a given intersection based on factors such as system load and/or occupancy, weather conditions, vehicle system state or status, traffic conditions, or the like. The control system may also change the parameters of the moving position-targets on any of its trunk lanes and/or intersections based on similar factors. As one example, under low or light loading conditions (e.g., outside of rush hour times), the control system may operate trunk lanes with greater vehicle spacing (e.g., by defining moving position-targets with greater vehicle spacing), and may operate an intersection by interleaving or alternating the moving position-targets through the intersection. As another example, where one trunk lane is being operated with a higher throughput (e.g., greater flow rate of moving position-targets) than an intersecting trunk lane, the control system may transition the intersection to a single buffer configuration, in which the higher-throughput lane is operated using continuous moving position-targets through the intersection, while the lower-throughput lane ends at a buffer zone adjacent the intersection.

While FIGS. 8A-9D illustrate single lanes of traffic and individual vehicles, it will be understood that the same or similar techniques may be used to route multiple vehicles (e.g., platoons of vehicles) through intersections, and to route vehicles through multi-lane intersections (e.g., with multiple lanes of traffic in a given direction).

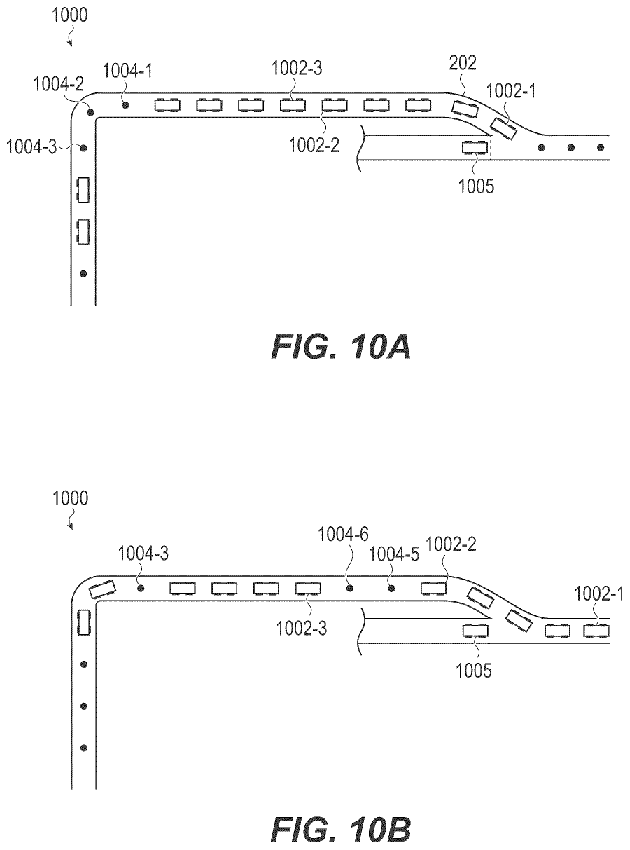

As described herein, vehicles may be assigned to moving position-targets in order to traverse trunk lanes. Under certain circumstances, trunk lanes may become congested, and it may be difficult for vehicles at a boarding zone to acquire a moving position-target on a congested trunk lane. FIGS. 10A-10B illustrate an example technique by which the control system of a transportation system may adjust the moving position-target assignments on a trunk lane in order to accommodate vehicles attempting to enter the trunk lane from a boarding zone.

FIG. 10A illustrates a portion 1000 of a transportation system that includes the trunk lane 202. A vehicle 1005 may be waiting to join the trunk lane 202. As shown, the vehicle 1005 is at an output buffer position, but it will be understood that the operations described with respect to these figures may be applied for a vehicle that is still in a parking spot in a boarding zone (or at a buffer zone at an intersection).

As shown in FIG. 10A, the trunk lane is heavily utilized, with a number of vehicles 1002 occupying consecutive moving position-targets 1004. As such, the first moving position-target available for the vehicle 1005 (e.g., moving position-target 1004-1) may result in a significant departure delay for the vehicle 1005. Thus, in accordance with a determination that a departure delay satisfies a condition, the control system (e.g., a boarding zone router in conjunction with a trunk lane router) may instruct some vehicles on the trunk lane to shift moving position-targets in order to create a free moving position-target farther downstream. The condition may be a time condition (e.g., if the delay is greater than 1 minute, 2 minutes, 5 minutes, etc.), a distance condition (e.g., if the next available moving position-target is greater than about 0.5 miles upstream, 1.0 mile upstream, 1.5 miles upstream, etc.), or a moving position-target condition (e.g., if the next available moving position-target is more than 10 positions upstream, 20 positions upstream, 30 positions upstream, etc.).

In accordance with a determination that a departure delay satisfies a condition, the control system may instruct a set of vehicles to transition to an upstream moving position-target. For example, as shown in FIG. 10A, the control system may determine that moving position-targets should be introduced between vehicles 1002-2 and 1002-3 in the trunk lane 202 in order to accommodate vehicles entering the trunk lane 202. Accordingly, the control system may identify a subset of vehicles that can be shifted to upstream moving position-targets, such as by identifying unoccupied (and unreserved) moving position-targets that are upstream of a set of adjacent vehicles (e.g., moving position-targets 1004-1, 1004-2, 1004-3, FIG. 10A). More particularly, as seen in FIG. 10B, the control system may determine that moving position-targets 1004-5, 1004-6 can be made available by shifting the vehicle 1002-3 (and the line of adjacent trailing vehicles) upstream by two moving position-targets.

In order to safely achieve this, each subject vehicle may be provided with instructions that will cause it to transition upstream by the target number of moving position-targets. Upon receiving such instructions, the vehicles may acknowledge that the instructions were received. If any of the subject vehicles fail to acknowledge the instructions, the moving position-target shifting operation may be aborted, and all vehicles may be instructed to continue along their previous trajectories. If the vehicles all acknowledge the instruction, the vehicles may begin to transition upstream, starting with the rear-most vehicle of the subject set. Once the rear-most vehicle has transitioned to an upstream moving position-target, the next vehicle may transition upstream as well. In some cases, all of the vehicles transition to upstream moving position-targets substantially simultaneously and/or in synchrony with one another. In such cases, the transitioning vehicles may communicate via inter-vehicle communication systems to ensure that all vehicles acknowledge the instructions and are prepared to execute the synchronized maneuver. In accordance with all vehicles acknowledging the instructions and confirming (at least to a trailing vehicle) they have received the instructions and are prepared to execute the maneuver, the vehicles may transition upstream to their new moving position-targets.

FIG. 10B illustrates the result of a transition operation in accordance with the foregoing. In particular, the vehicles upstream of vehicle 1002-2 have shifted rearward by two moving position-targets, making moving position-targets 1004-5, 1004-6 available for the waiting vehicle 1005 (and optionally other vehicles). Accordingly, the vehicle 1005 may be able to join the trunk lane earlier, with little overall impact on the transit time of the vehicles already travelling in the trunk lane 202.

Notably, the systems and techniques described herein for routing vehicles throughout the roadways of a transportation system are highly scalable and can facilitate efficient and seamless expansion of transportation systems, as well as efficient and seamless merging of separate transportation systems. For example, the transportation systems described herein use a combination of trunk lanes, which use moving position-target deconfliction techniques to safely and simply route vehicles, and nodes (e.g., boarding zones, intersections, and transition zones), which use trajectory deconfliction techniques. Moreover, the trunk lanes are associated with trunk routers, which manage the assignment of vehicles to the moving position-targets on a trunk lane, and the nodes are associated with node routers (e.g., boarding zone routers, intersection routers, transition zone routers), which manage the movement of vehicles through the associated node and onto the trunk lanes.

Further, as described herein, a node router for a given node of the transportation system may be configured to cooperate with the trunk routers of the trunk lanes that are accessible from the given node in order to assign moving position-targets to a vehicle, and more particularly, to route vehicles from the node and along the trunk lane to a next node of the trip (which may be a final or intermediate boarding zone, an intersection, a transition zone, or the like). Thus, for a given trip, a node router (e.g., a boarding zone router) can provide a trajectory that extends fully to a next node, and the next node router then handles the next leg of the trip (e.g., routing the vehicle to a farther node, routing the vehicle to a parking spot, across an intersection to another trunk lane, or the like).

In total, the techniques and systems described herein can assemble a trip for a vehicle from multiple trajectory segments, each trajectory segment extending from one node, along a trunk lane, to another node. As noted, nodes may be boarding zones, intersections, transition zones (e.g., transitions between trunk lanes managed by different trunk routers), or the like. This system allows for rapid and seamless expansion of the transportation system, as each node router need only determine a trajectory to a next node by cooperating with an adjoining trunk lane.

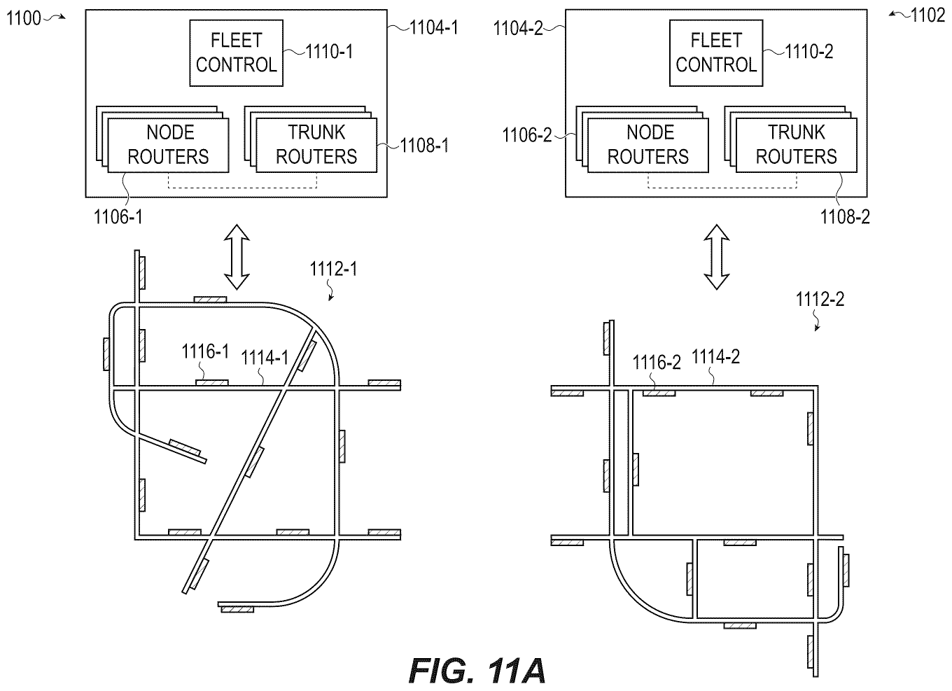

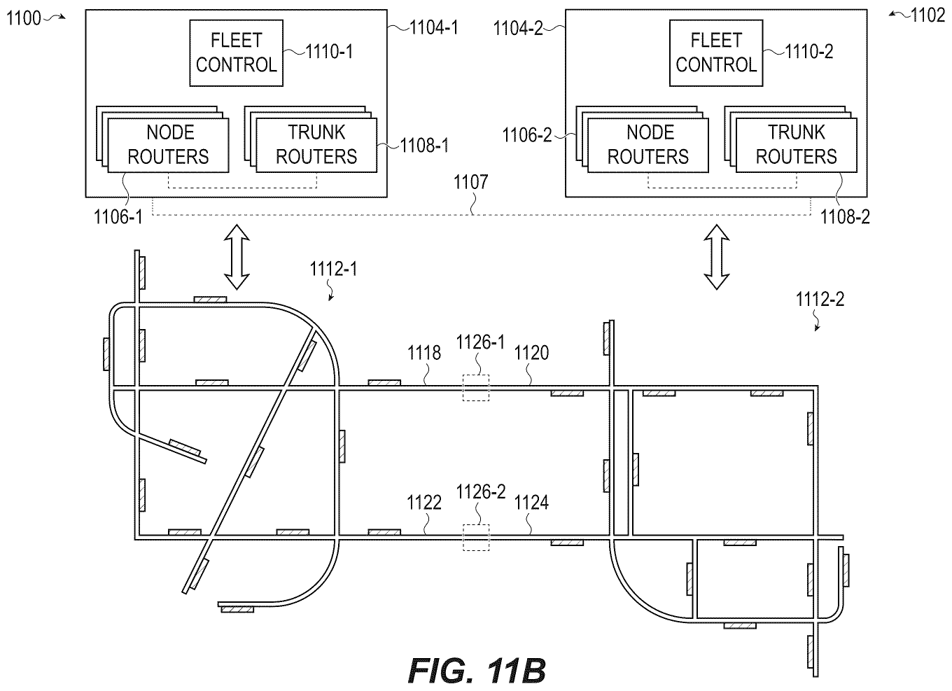

FIGS. 11A-11B illustrate how the systems and techniques described herein facilitate the ad hoc coupling of separate roadway systems. FIG. 11A illustrates two transportation systems 1100, 1102. The transportation systems 1100, 1102 may be entirely separate in their initial configurations. For example, each transportation system may be associated with physically distinct roadway systems 1112-1, 1112-2, and may include separate control systems 1104-1, 1104-2 that control the operations of the transportation systems. The control systems 1104 may be embodiments of or otherwise correspond to the control system 101 (FIG. 1B). The transportation systems 1100, 1102 may, for example, correspond to transportation systems of different cities, towns, regions, etc., which are operated independently of one another. Each transportation system may include trunk lanes (e.g., trunk lanes 1114-1, 1114-2) and boarding zones (e.g., boarding zones 1116-1, 1116-2). The transportation systems may also include any number of other nodes, as described herein (e.g., trunk lane intersections, parking lots, etc.).

The control systems 1104-1, 1104-2 each include separate node routers 1106, trunk routers 1108, and fleet control systems 1110. The fleet control systems 1110 may maintain a registry of each vehicle operating in its associated transportation system (e.g., the vehicle fleet for that transportation system), as well as information about each vehicle. Example vehicle information may include, without limitation, vehicle location, current occupant, next scheduled location, vehicle maintenance records, and the like.

The node routers 1106 (e.g., boarding zone routers) and trunk routers 1108 of each control system 1104 may operate as described herein. For example, a node router for a node (e.g., a boarding zone) may cooperate with trunk routers to reserve moving position-targets on a trunk lane, and may route a vehicle from the node, along the trunk lane, to a next node along the vehicle's path. Notably, the transportation systems 1100, 1102 may operate completely independently of one another.

FIG. 11B illustrates the transportation systems 1100, 1102 having been joined together at two nodes 1126-1, 1126-2. Such joining may occur when the transportation systems grow sufficiently close to one another that joining them becomes feasible or otherwise desirable. More particularly, a trunk lane 1118 of the first transportation system 1100 and a trunk lane 1120 of the second transportation system 1102 may be joined at node 1126-1, and a trunk lane 1122 of the first transportation system 1100 and a trunk lane 1124 of the second transportation system 1102 may be joined at node 1126-2.

As described herein, each trunk lane 1118, 1120, 1122, 1124 may be associated with its own moving position-target system, and may be managed by a trunk router of its own control system. For example, the trunk lanes 1118, 1122 may be associated with their own respective moving position-target schemes and may be managed by trunk routers 1108-1 of the first control system 1104-1, and the trunk lanes 1120, 1124 may be associated with their own respective moving position-target schemes and may be managed by trunk routers 1108-2 of the second control system 1104-2. By allowing each trunk lane to maintain its own moving position-target scheme, the separate transportation systems can be easily joined without having to reconfigure or unify the trunk routers for the formerly separate trunk lanes.

Further, the nodes 1126-1, 1126-2 may be operated as nodes that are associated with node routers in a control system (e.g., one or the other control system 1104-1, 1104-2). More particularly, when the transportation systems are joined, one of the control systems may be updated to include node routers for the nodes 1126.

The node routers for the nodes 1126 may also be afforded access to trunk routers of at least those trunk lanes that meet at the nodes. Thus, for example, the node router for the node 1126-1 may be communicably coupled (e.g., via one or more communications networks) to trunk routers for the trunk lanes 1118 and 1120, regardless of which control system the trunk router is associated with. Thus, a trunk router may be part of a different control system than the node router. However, since the node routers and trunk routers in each system may operate in substantially the same way, the operation of a node router with respect to a trunk router of a different control system may be substantially the same as the operations with respect to a trunk router in the same control system. As a specific example, the node router for the node 1126-1 may cooperate with a trunk router 1108-1 of the first control system 1104-1 to reserve moving position-targets on the trunk lane 1118 (e.g., for vehicles coming from the trunk lane 1120), and may cooperate in the same or similar manner with a trunk router 1108-2 of the second control system 1104-2 to reserve moving position-targets on the trunk lane 1120 (e.g., for vehicles coming from the trunk lane 1118). Thus, the entire second transportation system 1102 may be accessible to the first transportation system by communicatively coupling a node router to the trunk routers of two otherwise separate transportation systems.

In some cases, other aspects of the control systems may also be coupled or otherwise integrated. For example, the central management systems (e.g., central management systems 102) of each control system may be merged so that a single common central management system is used to allocate system resources across the unified transportation system and otherwise manage the overall system operations. For example, a unified central management system may determine paths, for trip requests, that include segments in both roadway systems.

In some cases, each control system remains largely independent of the other (e.g., they do not share a single central management system). In such cases, the control systems may be configured to communicate with one another to facilitate operation of the joined system. For example, a central management system of one control system may communicate with a central management system of another control system in order to generate a path that spans parts of both roadways. As a specific example, a first central management system may determine, for a trip request, a path segment from an origin boarding zone to a transition zone between the transportation systems, and then request, from another central management system, a path segment from the transition zone to the destination boarding zone.

In yet other examples, when transportation systems are joined as shown in FIG. 11B, a single control system manages the joined transportation system. For example, the control systems 1104-1, 1104-2 may be joined or merged to form a single control system (or a single control system may replace the control systems 1104-1, 1104-2).

In some cases, transitions between roadway systems that are managed by separate control systems may be effectuated without a dedicated node router for the transition zone. For example, in some cases, different portions of a contiguous lane (e.g., trunk lanes 1118, 1120) may be associated with moving position-targets that are managed by different control systems. For example, the first control system 1104-1 (e.g., a trunk router 1108-1 of the first control system 1104-1) may manage a set of moving position-targets along the trunk lane 1118 up to the transition zone 1126-1, and the second control system 1104-2 (e.g., a trunk router 1108-2 of the second control system 1104-2) may manage a set of moving position-targets along the trunk lane 1120 up to the transition zone 1126-1. In such cases, the moving position-targets may be substantially synchronized, such that a vehicle travelling through the transition zone 1126 may continue without changing speeds or experiencing other disruptions.

The use of separate moving position-target schemes on a contiguous roadway that joins roadway systems under the management of different control systems allows vehicles to smoothly transition between the roadway systems while also allowing each control system to manage the vehicles in its own roadway system. In particular, the following discussion describes how vehicles may be routed through a transportation system that includes two roadway systems that are joined at one or more nodes, such as the roadway systems 1112-1, 1112-2 in FIG. 11B. For example, at a first control system of a first roadway system (e.g., control system 1104-1 for the roadway system 1112-1), a trip request may be received from a user. The trip request may specify an origin boarding zone in the first roadway system 1112-1 and a destination boarding zone in the second roadway system 1112-2.

The first control system 1104-1 may select a vehicle for the trip request from the set of vehicles that it manages (e.g., vehicles in the first roadway system, using the fleet control system 1110-1). When selecting vehicles, control systems 1104 may select from the fleet of vehicles that is registered to that control system and/or roadway system (e.g., each control system will select from its own fleet of vehicles).

The first control system 1104-1 may determine a first path segment for the trip request, the first path segment extending from the origin boarding zone, along at least a portion of a first trunk lane of the first roadway system 1112-1, to a transition zone 1126 between the first roadway system 1112-1 and the second roadway system 1112-2. In this case, the first control system 1104-1 does not need to determine the portion of the path that is in the second roadway system 1112-2, as that operation will be handled by the second control system 1104-2.

The first control system 1104-1 (e.g., a boarding zone router and/or trunk router of the first control system 1104-1) may select a first moving position-target from a set of first candidate moving position-targets defined along the first trunk lane.

The first control system 1104-1 may also request, from the second control system of the second roadway system, a second path segment extending from the transition zone, along at least a portion of a second trunk lane of the second roadway system (e.g., the trunk lane 1120), to the destination boarding zone. This may occur, for example, when the first control system 1104-1 is determining the portion of the path that extends to the transition zone, and may serve to inform the second control system 1104-2 that a vehicle will be entering the second roadway system 1112-2 from the first roadway system 1112-1. By requesting (and receiving) the second path segment, the first control system 1104-1 and the second control system 1104-2 may together predefine the entire path of the vehicle from its origin to its destination, despite the path having segments in both roadway systems.

Additionally, the first control system 1104-1 (e.g., a node router of the first control system 1104-1 that manages the transition zone 1126) may request, from a trunk router associated with the second trunk lane 1120 (which may be associated with the second control system 1104-2), a second moving position-target from a set of second candidate moving position-targets defined along the second trunk lane 1120. By requesting (and receiving) the second moving position-target from the second control system 1104-2, the first control system 1104-1 and the second control system 1104-2 may together predefine the particular moving position-targets that the vehicle will follow in order to traverse a contiguous trunk lane, despite the trunk lane having separately managed moving position-target schemes.

The communications and/or cooperation between the control systems (e.g., for requesting path segments and moving position-target reservations between control systems) is highly efficient and scalable, because each router operates substantially the same whether it is communicating with another local router or a router in a separate control system. For example, a boarding zone router in a first control system requests moving position-targets from trunk lane routers in both the first and second control systems in the same or substantially the same manner (e.g., it may use the same or similar application programming interface (API) calls to each trunk router). Similarly, a trunk router in one control system may receive and respond to requests (e.g., API calls) from boarding zone routers (or other node routers) in any other control system.

When requesting the second moving position-target, the requesting router (in the first control system 1104-1) and the trunk router (in the second control system 1104-2) may cooperate to select a moving position-target that results in a smooth transition between the moving position-targets. For example, the second moving position-target may begin at the location that the first moving position-target ends, and may have the same or substantially the same vehicle velocity, acceleration, jerk, or other motion parameter. Accordingly, the vehicle transition from the first to the second moving position-target may occur without slowing or other disruption. In some cases, the requesting router provides information about the first moving position-target to the trunk router of the second trunk lane, thereby allowing the trunk router to select an appropriate second moving position-target. Moreover, as described herein, the trunk router for the second trunk lane may select a second moving position-target that is scheduled to be unoccupied for the entire time the vehicle is on the second trunk lane. In some cases, the vehicle will not be permitted to embark on its trip until first and second moving position-targets are selected that are adjacent and/or continuous with one another, and are each unoccupied for the vehicle's entire journey along the associated trunk lanes. Thus, once the vehicle starts its trip, the travel along the portions of the first and second trunk lanes and through the transition zone may be seamless.

In response to the path and the moving position-targets being determined for the vehicle, the vehicle is caused to travel along the portion of the first trunk lane by following the first moving position-target, and at the transition zone, transition from following the first moving position-target to following the second moving position-target (e.g., such that the vehicle continues to travel along the portion of the second trunk lane according to the second moving position-target). As described herein, the transition may occur without the vehicle slowing or stopping, as the moving position-targets along the trunk lanes may define a continuous trajectory (e.g., having a same speed, acceleration, jerk, direction of travel, etc.)

In some cases, when a vehicle transitions, at a transition zone, from following the first moving position-target to following the second moving position-target, the vehicle is deregistered from a vehicle fleet associated with the first control system, and registered with a vehicle fleet associated with the second control system. For example, the first fleet control system 1110-1 may inform the second fleet control system 1110-2 that the vehicle has been deregistered from the first roadway system and request that the second fleet control system 1110-2 register the vehicle and assume authority over the vehicle. In this way, each control system for each roadway system manages only those vehicles that are operating on its associated roadway system.

The foregoing operations ultimately result in the vehicle travelling along the portion of the first trunk lane by following the first moving position-target, and, at the transition zone, transitioning from following the first moving position-target to following the second moving position-target. In this way, the vehicle is routed between two roadway systems that are largely managed independently of one another, but which can efficiently and easily manage inter-roadway system trips.

In some cases, transitions between separately managed trunk lanes (and thus between separately managed roadway systems) use trajectory deconfliction techniques, such as those described herein with respect to other nodes (e.g., intersections and boarding zones). For example, a transition zone may include input and/or output buffers and may be associated with node routers, which determine how to route arriving vehicles through the transition zone and onto a next trunk lane (which may be associated with a different control system than the trunk lane that the vehicle arrived on). Thus, when transportation systems are joined, as described herein, the process by which node routers route vehicles within a single transportation system may be leveraged to facilitate routing operations between the different roadway systems.

For example, at a first control system of a first roadway system (e.g., control system 1104-1 for the roadway system 1112-1), a trip request may be received from a user. The trip request may specify an origin boarding zone in the first roadway system 1112-1 and a destination boarding zone in the second roadway system 1112-2. As described herein, the first control system 1104-1 may be configured to determine vehicle paths within the first roadway system.

The first control system 1104-1 may select a vehicle for the trip request from the set of vehicles that it manages (e.g., vehicles in the first roadway system, using the fleet control system 1110-1). When selecting vehicles, control systems 1104 may select from the fleet of vehicles that is registered to that control system and/or roadway system (e.g., each control system will select from its own fleet of vehicles).

The first control system 1104-1 (e.g., a boarding zone router 1106-1 of the first control system) may determine a path segment for the trip request, the path segment extending from the origin boarding zone, along at least a portion of a first trunk lane of the first roadway system 1112-1, to a transition zone 1126 (e.g., which may be an intersection where trunk lanes of previously distinct roadway systems meet) between the first roadway system 1112-1 and the second roadway system 1112-2.

The boarding zone router may select a first moving position-target from a set of first candidate moving position-targets defined along the first trunk lane. For example, a boarding zone router for the origin boarding zone may request a moving position-target from a trunk router for the first trunk lane, and the trunk router may select a moving position-target, as described herein, and provide information about the moving position-target assignment to the boarding zone router.

Once the moving position-target is selected, the vehicle may be caused to embark on its trip. For example, the boarding zone router may instruct the vehicle to exit its parking spot, traverse the boarding zone, and join the first trunk lane at the selected moving position-target.

Once the vehicle is travelling, the second control system 1104-2 of the second roadway system 1112-2 (e.g., an intersection router) may detect arrival of the vehicle at a buffer position proximate the intersection (e.g., a predefined position in a first segment of the first trunk lane). For example, the second control system 1104-2 may include an intersection router that manages vehicle traffic through the intersection and onto one or more of the trunk lanes that meet at the intersection. The arrival may be detected by the intersection router as described above with vehicles approaching a boarding zone router.

The intersection router may cause the vehicle to pause at the buffer position, as described herein. In some cases, such as if the buffer zone is unoccupied and a deconflicted trajectory through the intersection and onto a reserved moving position-target on the second trunk lane has been identified, the vehicle may continue without pausing at a buffer position.

When the vehicle arrives at or approaches the intersection, the intersection router may select a second moving position-target from a set of second candidate moving position-targets defined along the second trunk lane 1120. The intersection router may also determine another path segment (e.g., a second path segment) that extends from the intersection to a next node (e.g., a destination boarding zone). In some cases, the path segments that are determined by the boarding zone router and the intersection router may define a complete path for the vehicle from an origin boarding zone to a destination boarding zone.

The intersection router may also determine a path through the intersection and to the selected second moving position-target, as described herein. For example, the intersection router may determine a proposed trajectory segment from the buffer position, through the intersection, and to the selected second moving position-target. The intersection router may determine whether the proposed trajectory segment will cause the vehicle to contact other respective vehicles traversing other respective trajectory segments through the intersection. In response to determining that the proposed trajectory segment will not cause the vehicle to contact another respective vehicle traversing another respective trajectory segment through the intersection, the intersection router may cause the vehicle to depart the buffer position and travel along the proposed trajectory segment to the second moving position-target.

As described herein, an intersection router at an intersection joining trunk lanes of different roadway systems may route vehicles in a manner similar to other intersection routers (or boarding zone routers) described herein. For example, the intersection router may, in response to determining that the proposed trajectory segment will cause the vehicle to contact another respective vehicle traversing another respective trajectory segment through the intersection, delay the vehicle's departure from the buffer position. After delaying the vehicle's departure from the buffer position for a duration, the intersection router may determine whether a second proposed trajectory segment from the buffer position, through the intersection, and to the selected second moving position-target will cause the vehicle to contact other respective vehicles traversing other respective trajectory segments through the intersection, and in response to a determination that the second proposed trajectory segment will not cause the vehicle to contact another respective vehicle traversing another respective trajectory segment through the intersection, the intersection router may cause the vehicle to depart the buffer position and travel along the second proposed trajectory segment to the second moving position-target.

Additionally, the intersection router may manage transit through a buffer zone as described herein. For example, the intersection router may detect an upcoming arrival of the vehicle at the transition zone, where the vehicle is travelling along an initial path that terminates at the outermost buffer position. In accordance with a determination that the downstream buffer position is scheduled to be unoccupied at a time of arrival of the vehicle at the transition zone, the intersection router may send an updated trajectory segment to the vehicle, where the updated trajectory segment terminates at the downstream buffer position.

Thus, the foregoing describes how intersection deconfliction and vehicle routing techniques may be used to efficiently route vehicles between otherwise separately managed roadway systems. This allows separate roadway systems and/or transportation systems to be efficiently and scalably joined in an ad hoc manner. Communication between control systems 1104 (e.g., between the first and second control systems 1104-1, 1104-2) and/or the components of the control systems may be facilitated by a communication link 1107, which may include one or more wired and/or wireless communication links.

FIGS. 11A-11B illustrate the joining of two initially distinct transportation systems, but this is merely an example, and the techniques and systems described herein may facilitate the joining of an arbitrary number of transportation systems and/or roadway networks. Moreover, FIGS. 11A-11B illustrate the roadway systems joined along two contiguous trunk lanes. Here too, the techniques and systems described herein facilitate efficient coupling of roadway systems with an arbitrary number of trunk lanes. In particular, operating the transition zones as described herein (e.g., with a seamless transfer of a vehicle between moving position-targets or by using trajectory deconfliction at trunk lane intersections) allows any number of trunk lane connections between formerly distinct roadway systems with minimal impact to the operation of either control system.

As described herein, a transportation system may use multiple different deconfliction schemes at different regions of the transportation system (and at different portions of a trip through the transportation system). The particular combination of deconfliction schemes as used herein provides numerous advantages to the overall system operation and facilitates fully deconflicted operations while maintaining a highly scalable, on-demand user experience. For example, as described herein, trajectory comparison deconfliction schemes may be used at boarding zones, intersections, and other contested zones, while moving position-target schemes are used along trunk lanes. In total, a trajectory from an origin to a destination may include multiple segments that employ trajectory comparison deconfliction schemes and multiple segments that employ moving position-target schemes. Such trajectories may use trajectory comparison deconfliction schemes to seamlessly link distinct moving position-target schemes, while maintaining full deconfliction of each vehicle's trajectory.

The transportation systems described herein may be configured for numerous vehicles to be autonomously operated to transport passengers and/or freight along roadway systems. For example, a transportation system or service may provide a fleet of vehicles that operate within the roadway system. Vehicles in such a transportation system may be configured to operate autonomously, such as according to one or more vehicle schemes as described herein (e.g., by following deconflicted trajectories assigned thereto to facilitate transport and boarding operations, among other possible vehicle operations/maneuvers). As used herein, the term “autonomous” may refer to a mode or scheme in which vehicles can operate without continuous, manual control by a human operator. For example, driverless vehicles may navigate along a roadway using a system of automatic drive and steering systems that control the speed and direction of the vehicle. In some cases, the vehicles may not require steering, speed, or directional control from the passengers, and may exclude controls such as passenger-accessible accelerator and brake pedals, steering wheels, and other manual controls. In some cases, the vehicles may include manual drive controls that may be used for maintenance, emergency overrides, or the like. Such controls may be hidden, stowed, or otherwise not directly accessible by a user during normal vehicle operation. For example, they may be designed to be accessed only by trained operators, maintenance personnel, or the like.

Autonomous operation need not exclude all human or manual operation of the vehicles or of the transportation system as a whole. For example, human operators may be able to intervene in the operation of a vehicle for safety, convenience, testing, or other purposes. Such intervention may be local to the vehicle, such as when a human driver takes control of the vehicle, or remote from the vehicle, such as when an operator sends commands to the vehicle via a remote-control system. Similarly, some aspects of the vehicles may be controlled by passengers of the vehicles. For example, a passenger in a vehicle may select a target destination, a path, a speed, control the operation of the doors and/or windows, or the like. Accordingly, it will be understood that the terms “autonomous” and “autonomous operation” do not necessarily exclude all human intervention or operation of the individual vehicles or of the overall transportation system.

The vehicles in the transportation system may include various sensors, cameras, communications systems, processors, and/or other components or systems that help facilitate autonomous operation. For example, the vehicles may include a sensor array that detects magnets or other markers embedded in the roadway and which help the vehicle determine its location, position, and/or orientation on the roadway. The vehicles may also include wireless vehicle-to-vehicle communications systems, such as optical communications systems, that allow the vehicles to inform one another of operational parameters such as their braking status, the number of vehicles ahead in a platoon, acceleration status, their next maneuver (e.g., right turn, left turn, planned stop), their number or type of payload (e.g., humans or freight), or the like. The vehicles may also include wireless communications systems to facilitate communication with a transportation control system that has supervisory command and control authority over the transportation system.

The vehicles in the transportation system may be designed to enhance the operation and convenience of the transportation system. For example, a primary purpose of the transportation system may be to provide comfortable, convenient, rapid, and efficient personal transportation. To provide personal comfort, the vehicles may be designed for easy passenger ingress and egress, and may have comfortable seating arrangements with generous legroom and headroom. The vehicles may also have a sophisticated suspension system that provides a comfortable ride and dynamically adjustable parameters to help keep the vehicle level, positioned at a convenient height, and to ensure a comfortable ride throughout a range of variable load weights.

Conventional personal automobiles are designed for operation primarily in only one direction. This is due in part to the fact that drivers are oriented forwards, and operating in reverse for long distances is generally not safe or necessary. However, in autonomous vehicles, where humans are not directly controlling the operation of the vehicle in real-time, it may be advantageous for a vehicle to be able to operate bidirectionally. For example, the vehicles in a transportation system as described herein may be substantially symmetrical, such that the vehicles lack a visually or mechanically distinct front or back. Further, the wheels may be controlled sufficiently independently so that the vehicle may operate substantially identically no matter which end of the vehicle is facing the direction of travel. This symmetrical design provides several advantages. For example, the vehicle may be able to maneuver in smaller spaces by potentially eliminating the need to make U-turns or other maneuvers to re-orient the vehicles so that they are facing “forward” before initiating a journey.

FIGS. 12A and 12B are perspective views of an example four-wheeled roadway vehicle 1200 (referred to herein simply as a “vehicle”) that may be used in a transportation system as described herein. FIGS. 12A-12B illustrate the symmetry and bidirectionality of the vehicle 1200. In particular, the vehicle 1200 defines a first end 1202, shown in the forefront in FIG. 12A, and a second end 1204, shown in the forefront in FIG. 12B. In some examples and as shown, the first and second ends 1202, 1204 are substantially identical. Moreover, the vehicle 1200 may be configured so that it can be driven with either end facing the direction of travel. For example, when the vehicle 1200 is travelling in the direction indicated by arrow 1214, the first end 1202 is the leading end of the vehicle 1200, while when the vehicle 1200 is traveling in the direction indicated by arrow 1212, the second end 1204 is the leading end of the vehicle 1200.

The ability of the vehicles to operate bidirectionally may allow the roadway systems, and in particular boarding zones, to be made more compact. For example, when a vehicle that is configured to travel primarily only in one direction (e.g., with reverse operation being provided for convenience and maneuvering, but not for continuous driving functions) pulls into a blind parking spot, it must execute a y-turn maneuver in order to exit the parking spot and begin forward travel. On the other hand, a vehicle configured to operate equally well in either direction (e.g., a bidirectional vehicle) may simply exit the parking spot already facing the direction of travel. Accordingly, vehicles capable of bidirectional operation require less space to maneuver in boarding zones, allowing the boarding zones to be more compact and operate more efficiently. For example, a y-turn maneuver could temporarily block more adjacent parking spots than a vehicle that can simply turn directly towards its desired direction of travel, regardless of which direction that is. And while pull-through parking spots may eliminate the need to perform y-turn maneuvers in unidirectional vehicles, boarding zones with pull-through parking spots require a larger area than those with blind parking spots. Accordingly, using bidirectional vehicles, such as the vehicle 1200, facilitates the use of smaller, more compact boarding zones and more efficient operation of the boarding zones.

The vehicle 1200 may also include wheels 1206 (e.g., wheels 1206-1-1206-4). The wheels 1206 may be paired according to their proximity to an end of the vehicle. Thus, wheels 1206-1, 1206-3 may be positioned proximate the first end 1202 of the vehicle and may be referred to as a first pair of wheels 1206, and the wheels 1206-2, 1206-4 may be positioned proximate the second end 1204 of the vehicle and may be referred to as a second pair of wheels 1206. Each pair of wheels may be driven by at least one motor (e.g., an electric motor), and each pair of wheels may be able to steer the vehicle. Because each pair of wheels is capable of turning to steer the vehicle, the vehicle may have similar driving and handling characteristics regardless of the direction of travel. In some cases, the vehicle may be operated in a two-wheel steering mode, in which only one pair of wheels steers the vehicle 1200 at a given time. In such cases, the particular pair of wheels that steers the vehicle 1200 may change when the direction of travel changes. In other cases, the vehicle may be operated in a four-wheel steering mode, in which the wheels are operated in concert to steer the vehicle. In a four-wheel steering mode, the pairs of wheels may either turn in the same direction or in opposite directions, depending on the steering maneuver being performed and/or the speed of the vehicle.

The vehicle 1200 may also include doors 1208, 1210 that open to allow passengers and other payloads (e.g., packages, luggage, freight) to be placed inside the vehicle 1200. The doors 1208, 1210, which are described in greater detail herein, may extend over the top of the vehicle such that they each define two opposite side segments. For example, each door defines a side segment on a first side of the vehicle and another side segment on a second, opposite side of the vehicle. The doors also each define a roof segment that extends between the side segments and defines part of the roof (or top side) of the vehicle. In some cases, the doors 1208, 1210 resemble an upside-down “U” in cross-section and may be referred to as canopy doors. The side segments and the roof segment of the doors may be formed as a rigid structural unit, such that all of the components of the door (e.g., the side segments and the roof segment) move in concert with one another. In some cases, the doors 1208, 1210 include a unitary shell or door chassis that is formed from a monolithic structure. The unitary shell or door chassis may be formed from a composite sheet or structure including, for example, fiberglass, carbon composite, and/or other lightweight composite materials.

The vehicle 1200 may also include a vehicle controller 1220 (FIG. 12C) that controls the operations of the vehicle 1200 and the vehicle's systems and/or subsystems. For example, the vehicle controller may control the vehicle's drive system, steering system, suspension system, doors, and the like, to facilitate vehicle operation, including navigating the vehicle along a roadway in accordance with one or more vehicle control schemes and/or trajectories. The vehicle controller may also be configured to communicate with other vehicles, the transportation control system (e.g., the CMS 102, monitoring systems 106, the dispatch system 104, etc.), vehicle presence detectors, or other components of the transportation system. For example, the vehicle controller may be configured to receive information from other vehicles about those vehicles' position in a platoon, speed, upcoming speed or direction changes, or the like. The vehicle controller may also be configured to receive information from vehicle presence detectors about available vehicle positions. The vehicle controller may include computers, processors, memory, circuitry, or any other suitable hardware components, and may be interconnected with other systems of the vehicle to facilitate the operations described herein, as well as other vehicle operations.

FIG. 12C is a schematic representation of the vehicle 1200, illustrating an example set of systems that may facilitate and/or implement the operations and techniques described herein. The vehicle 1200 may include a vehicle controller 1220. The vehicle controller 1220 may include a vehicle sensing subsystem 1222, a vehicle communications subsystem 1224, a vehicle autonomy subsystem 1226, a vehicle controls subsystem 1228, and a vehicle user interface (UI) subsystem 1230. The vehicle controller 1220 may be coupled to various physical and/or hardware components of the vehicle 1200, including but not limited to propulsion system(s) 1232, steering system(s) 1234, braking system(s) 1236, sensor(s) and/or sensing system(s) 1238, door system(s) 1240, user interface system(s) 1242, and the like.

The vehicle sensing subsystem 1222 may include or be coupled to sensing systems 1238, which may include tri-band redundant sensing (lidar, radar, camera), providing high-resolution (e.g., about 0.2 to about 2.0 mrad), low-latency (e.g., less than about 100 ms latency), and long-range sensor data (e.g., greater than about 600 ft). The vehicle sensing subsystem 1222 may provide and/or access sensor data that is used to determine vehicle state (e.g., position, velocity, acceleration) as well as to provide detection and localization of other objects in the system including other vehicles and any intrusions into the system.

The vehicle communications subsystem 1224 may include dual-band redundant wireless communications. This subsystem may receive trajectory information (e.g., fully deconflicted vehicle trajectories) and movement authority signals (where the movement authority signal is a continuous signal required for any permissive state on the system). The vehicle communications subsystem 1224 may also transmit vehicle state information to other system components (e.g., other vehicles, the CMS 102, monitoring systems 106, the dispatch system 104, etc.). The vehicle communications subsystem 1224 may also transmit and/or receive redundant/diverse system observations (e.g., intrusion observations, vehicle observations) across the system. Generally and broadly, the vehicle communications subsystem 1224 may provide communications functionality for receiving communications from and sending communications to other systems (e.g., a control system of the transportation system, other vehicles, a dispatch system, a central management system, a monitoring system, etc.). As a nonlimiting example, the vehicle communications subsystem 1224 may receive vehicle trajectories from a control system.

The vehicle autonomy subsystem 1226 may facilitate the autonomous operation of the vehicle 1200 including assuring the safety of the vehicle 1200 in varied conditions including any and all failures of off-vehicle components (e.g., the CMS 102, monitoring systems 106, the dispatch system 104, etc.). The vehicle autonomy subsystem 1226 may use the output of the vehicle sensing subsystem 1222 as input and, based at least in part on the output, provide vehicle ego-localization (e.g., the location of the vehicle 1200 in space and/or with respect to the transportation system) and object detection/localization (including other vehicles and foreign objects on or adjacent to the roadway). The vehicle autonomy subsystem 1226 may cross-check its ego-localization and object reports against diverse and redundant sources (e.g., reports from roadside monitoring systems and other vehicles) and may enforce safety invariants with respect to these results (e.g., maintaining safe separation distances, etc.). The vehicle may periodically (e.g., at a frequency of about 10 cycles per second) or otherwise provide both a current safe motion plan and a fail-safe motion plan to the vehicle controls subsystem 1228 (to be executed in the event a motion plan is not received on subsequent cycles).

The vehicle controls subsystem 1228 may control vehicle actuators (e.g., propulsion, braking, steering, doors, etc.) and may maintain the vehicle in a safe state. The vehicle controls subsystem 1228 may include safety-critical software running on safety-critical processing hardware (e.g., checked-redundancy via dual lockstep processors). The vehicle steering and braking systems may support a fail-safe design with respect to a loss of signal from the vehicle controls subsystem 1228 via hardware watchdog timers.

The vehicle user interface subsystem 1230 may facilitate user interactions within the vehicle including, without limitation, verifying passenger identity (via NFC scan), allowing the user to initiate the trip, and providing information to the user over the course of the trip (e.g., time to arrival, alert prior to arrival). The vehicle user interface subsystem 1230 may include displays, touchscreen displays, output systems (e.g., lights, speakers) user input systems (e.g., keyboard, buttons, microphones), as well as other possible user interface components or systems.

The vehicle user interface subsystem 1230 may provide various outputs and accept various inputs from passengers during a trip. For example, during a trip, the vehicle UI subsystem 1230 may communicate ride progress, display messages, and provide access to customer support.

In one example, once a rider enters the vehicle, the vehicle UI subsystem 1230 may provide an audio and/or visual output prompting the passenger to identify themselves (e.g., to present a credential item, ticket, etc.). The vehicle UI subsystem 1230 may also include an NFC antenna, optical scanner, or other system to allow the user to identify themselves or otherwise provide credentials to the system. After the passenger identifies themself, the vehicle UI subsystem 1230 may provide audio and/or visual outputs indicating that doors will close (and optionally providing a countdown, such as a 3 second countdown). At any point, the passenger can interact with the vehicle UI subsystem 1230 to stop the doors from closing. Once the doors are closed, the vehicle UI subsystem 1230 may provide an audio and/or visual output indicating that departure is imminent.

During the ride, a progress bar or other trip progress information (e.g., a moving indication on a map of the roadway system) may be displayed to the user, via the vehicle's user interface and/or on the user's device. During the ride, the user may access customer support via the vehicle or their mobile phone or other device. Prior to arrival at a destination, the vehicle UI subsystem 1230 may produce an audio and/or visual output indicating that they are about to arrive at their destination. A countdown may optionally be provided as well.

The various controllers, systems, subsystems, and/or other components, modules, etc., of the vehicle 1200 may include and/or be instantiated by one or more electronic devices (e.g., computer systems), such as the electronic device 1400 described with respect to FIG. 14.

The various systems, subsystems, modules, etc., of the vehicle 1200 may cause the vehicle 1200 to follow, track, or otherwise maintain coincidence with one or more setpoints provided and/or defined by a representation of a vehicle trajectory. For example, the vehicle 1200 may receive a representation of a vehicle trajectory that defines the vehicle's position, velocity, and acceleration (and optionally jerk and/or other trajectory parameters), and the vehicle controller 1220 may coordinate the operation of the vehicle systems and subsystems to cause the vehicle to traverse the vehicle trajectory. This may include, for example, controlling the steering system, the propulsion system, and the braking system to cause the vehicle to track the position, velocity, and acceleration targets (e.g., setpoints) throughout the trajectory. In some cases, the vehicle uses closed-loop control systems (using one or more feedback systems or sources, such as sensor data, data from a global positioning system (GPS), etc.) to track the targets. As noted, the vehicle may also execute safety functions that maintain the vehicle in a safe condition in view of unexpected conditions or events, even if that means deviating from its assigned trajectory.

FIGS. 13A and 13B are side and perspective views of the vehicle 1200 with the doors 1208, 1210 in an open state. Because the doors 1208, 1210 each define two opposite side segments and a roof segment, an uninterrupted internal space 1302 may be revealed when the doors 1208, 1210 are opened. In the example depicted in FIGS. 13A and 13B, when the doors 1208, 1210 are opened, an open section may be defined between the doors 1208, 1210 that extends from one side of the vehicle 1200 to the other. This may allow for unimpeded ingress and egress into the vehicle 1200 by passengers on either side of the vehicle 1200. The lack of an overhead structure when the doors 1208, 1210 are opened may allow passengers to walk across the vehicle 1200 without a limit on the overhead clearance.

The vehicle 1200 may also include seats 1304, which may be positioned at opposite ends of the vehicle 1200 and may be facing one another. As shown, the vehicle includes two seats 1304, though other numbers of seats and other arrangements of seats are also possible (e.g., zero seats, one seat, three seats, etc.). In some cases, the seats 1304 may be removed, collapsed, or stowed so that wheelchairs, strollers, bicycles, or luggage may be more easily placed in the vehicle 1200. For example, the seats may be hinged or otherwise articulatable such that the seat surface can be raised to provide more room in the vehicle for other objects. In some cases, the vehicle 1200 may include a bicycle retention system positioned below the seat surface, such that upon raising the seat surface, a bicycle wheel may be secured to the bicycle retention system. The bicycle retention system may include a slot 1305 into which a bicycle wheel may be at least partially inserted in order to maintain the bicycle in an upright configuration. The slot 1305 may be offset from a center line of the vehicle to provide adequate space for passengers and other payload.

FIG. 14 illustrates a sample electrical block diagram of an electronic device 1400 that may perform the operations described herein. The electronic device 1400 may in some cases take the form of any of the electronic devices described herein, including the CMS 102, the monitoring systems 106, the dispatch system 104 (including trunk routers and node routers such as boarding zone routers, intersection routers, transition zone routers, etc.), vehicle controller 1220 (or any other system, subsystem, module, etc., of a vehicle), vehicle user interfaces, boarding zone kiosks, portable electronic devices, or other computing devices or systems that are described herein or that are usable in order to perform the operations or instantiate the systems and/or services described herein. The electronic device 1400 can include one or more of a display 1412, a processing unit 1402, a power source 1414, a memory 1404 or storage device, input device(s) 1406, and output device(s) 1410. In some cases, various implementations of the electronic device 1400 may lack some or all of these components and/or include additional or alternative components.

The processing unit 1402 can control some or all of the operations of the electronic device 1400. The processing unit 1402 can communicate, either directly or indirectly, with some or all of the components of the electronic device 1400. For example, a system bus or other communication mechanism 1416 can provide communication between the processing unit 1402, the power source 1414, the memory 1404, the input device(s) 1406, and the output device(s) 1410.

The processing unit 1402 can be implemented as any electronic device capable of processing, receiving, or transmitting data or instructions. For example, the processing unit 1402 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1400 can be controlled by multiple processing units. For example, select components of the electronic device 1400 (e.g., an input device 1406) may be controlled by a first processing unit and other components of the electronic device 1400 (e.g., the display 1412) may be controlled by a second processing unit, where the first and second processing units may or may not be in communication with each other.

The power source 1414 can be implemented with any device capable of providing energy to the electronic device 1400. For example, the power source 1414 may be one or more batteries or rechargeable batteries. Additionally or alternatively, the power source 1414 can be a power connector or power cord that connects the electronic device 1400 to another power source, such as a wall outlet.

The memory 1404 can store electronic data that can be used by the electronic device 1400. For example, the memory 1404 can store electronic data or content such as, for example, trip requests, user information, historical usage data, maps and/or layouts of the transportation system, vehicle data (e.g., information about each vehicle in the system, including assignment status, remaining charge, maintenance history, etc.), or the like. The memory 1404 can be configured as any type of memory. By way of example only, the memory 1404 can be implemented as random access memory, read-only memory, Flash memory, removable memory, other types of storage elements, or combinations of such devices.

In various embodiments, the display 1412 provides a graphical output, for example, associated with an operating system, user interface, and/or applications of the electronic device 1400. In one embodiment, the display 1412 includes one or more sensors and is configured as a touch-sensitive (e.g., single-touch, multi-touch) and/or force-sensitive display to receive inputs from a user. For example, the display 1412 may be integrated with a touch sensor (e.g., a capacitive touch sensor) and/or a force sensor to provide a touch- and/or force-sensitive display. The display 1412 is operably coupled to the processing unit 1402 of the electronic device 1400.

The display 1412 can be implemented with any suitable technology, including, but not limited to liquid crystal display (LCD) technology, light emitting diode (LED) technology, organic light-emitting display (OLED) technology, organic electroluminescence (OEL) technology, or another type of display technology. In some cases, the display 1412 is positioned beneath and viewable through a cover that forms at least a portion of an enclosure of the electronic device 1400.

In various embodiments, the input device(s) 1406 may include any suitable components for detecting inputs. Examples of input device(s) 1406 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., GPS devices), thermal sensors, communication devices (e.g., wired or wireless communication devices), resistive sensors, magnetic sensors, electroactive polymers (EAPs), strain gauges, electrodes, and so on, or some combination thereof. Each input device 1406 may be configured to detect one or more particular types of input and provide a signal (e.g., an input signal) corresponding to the detected input. The signal may be provided, for example, to the processing unit 1402.

The output device(s) 1410 may include any suitable components for providing outputs. Examples of output device(s) 1410 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device 1410 may be configured to receive one or more signals (e.g., an output signal provided by the processing unit 1402) and provide an output corresponding to the signal(s).

In some cases, input device(s) 1406 and output device(s) 1410 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1402 may be operably coupled to the input device(s) 1406 and the output device(s) 1410. The processing unit 1402 may be adapted to exchange signals with the input device(s) 1406 and the output device(s) 1410. For example, the processing unit 1402 may receive an input signal from an input device 1406 that corresponds to an input detected by the input device 1406. The processing unit 1402 may interpret the received input signal to determine whether to provide and/or change one or more outputs in response to the input signal. The processing unit 1402 may then send an output signal to one or more of the output device(s) 1410, to provide and/or change outputs as appropriate.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. For example, while the methods or processes disclosed herein have been described and shown with reference to particular operations performed in a particular order, these operations may be combined, sub-divided, or re-ordered to form equivalent methods or processes without departing from the teachings of the present disclosure. Moreover, structures, features, components, materials, steps, processes, or the like, that are described herein with respect to one embodiment may be omitted from that embodiment or incorporated into other embodiments. Further, while the term “roadway” is used herein to refer to structures that support moving vehicles, the roadways described herein do not necessarily conform to any definition, standard, or requirement that may be associated with the term “roadway,” such as may be used in laws, regulations, transportation codes, or the like. As such, the roadways described herein are not necessarily required to (and indeed may not) provide the same features and/or structures of a “roadway” as defined or used in other contexts. Of course, the roadways described herein may comply with any and all applicable laws, safety regulations, or other rules for the safety of passengers, bystanders, operators, builders, maintenance personnel, or the like.

What is claimed is:

1. A method of operating a transportation system, comprising:
at a control system configured to determine respective paths for respective vehicles and to provide the respective paths to the respective vehicles:
receiving a trip request specifying an origin boarding zone and a destination boarding zone;
determining a path for the trip request, the path extending from the origin boarding zone and along at least a portion of a trunk lane of a roadway system, the trunk lane associated with a set of candidate moving position-targets defining vehicle position with respect to time along the trunk lane;
assigning the trip request to a vehicle;
determining, based at least in part on a location of a parking spot where the vehicle is parked at the origin boarding zone, an estimated transit duration of the vehicle from the parking spot to an entrance to the trunk lane;
selecting, based at least in part on the estimated transit duration, a moving position-target from the set of candidate moving position-targets; and
causing the vehicle to:
travel from the parking spot to the trunk lane; and
travel along the portion of the trunk lane by following the selected moving position-target.

2. The method of claim 1, wherein:
the origin boarding zone includes an output buffer zone for receiving vehicles exiting the origin boarding zone;
the destination boarding zone includes an input buffer zone for receiving vehicles entering the destination boarding zone; and
selecting the moving position-target comprises selecting an available moving position-target that is not assigned to any other vehicle between the output buffer zone at the origin boarding zone and the input buffer zone at the destination boarding zone.

3. The method of claim 1, wherein the path extends from the parking spot of the origin boarding zone to an input buffer position of the destination boarding zone.

4. The method of claim 3, wherein the input buffer position of the destination boarding zone is an outermost input buffer position.

5. The method of claim 4, wherein:
the outermost input buffer position is a first input buffer position; and
the method further comprises, in accordance with a determination that a second input buffer position downstream of the first input buffer position is scheduled to be unoccupied at a time of arrival of the vehicle at the destination boarding zone, sending an updated trajectory segment to the vehicle, the updated trajectory segment terminating at the second input buffer position.

6. The method of claim 1, wherein selecting the moving position-target from the set of candidate moving position-targets includes selecting a moving position-target that is configured to pass the origin boarding zone after the vehicle arrives at the entrance to the trunk lane.

7. The method of claim 1, wherein the set of candidate moving position-targets define non-intersecting vehicle positions along the trunk lane as a function of time.

8. The method of claim 1, further comprising causing the vehicle to delay travel from the parking spot to the trunk lane for a delay duration, the delay duration based at least in part on a time when the moving position-target is configured to pass the origin boarding zone.

9. The method of claim 1, wherein:
the method further comprises determining a spacetime trajectory for the vehicle, the spacetime trajectory defining at least a position, a speed, and an acceleration of the vehicle as a function of time from the parking spot to the moving position-target; and
causing the vehicle to travel from the parking spot to the trunk lane comprises causing the vehicle to traverse the spacetime trajectory.

10. A method of operating a transportation system, comprising:
at a control system configured to determine respective paths for respective vehicles and to provide the respective paths to the respective vehicles:
detecting an upcoming arrival of a vehicle at a destination boarding zone, wherein the vehicle is travelling along a path that terminates at an outermost input buffer position of a set of input buffer positions at the destination boarding zone;
selecting a parking spot, at the destination boarding zone, for the vehicle;
in accordance with a determination that a downstream input buffer position of the set of input buffer positions is scheduled to be unoccupied at a time of arrival of the vehicle at the destination boarding zone, sending an updated trajectory segment to the vehicle, the updated trajectory segment:
extending the path to the downstream input buffer position; and
including a path segment extending from the downstream input buffer position to the parking spot; and
causing the vehicle to traverse the updated trajectory segment.

11. The method of claim 10, wherein travelling along the path comprises following a moving position-target defining vehicle position with respect to time along a trunk lane that is connected to the destination boarding zone.

12. The method of claim 10, wherein selecting the parking spot comprises selecting a parking spot that is scheduled to be unoccupied at a time of arrival of the vehicle at the parking spot.

13. The method of claim 10, further comprising:
comparing the updated trajectory segment to respective trajectory segments of other respective vehicles scheduled to travel through the destination boarding zone during a same time as the vehicle; and
in accordance with a determination that the updated trajectory segment intersects a respective trajectory segment of at least one of the other respective vehicles, delaying a departure of the vehicle from the downstream input buffer position to the parking spot along the updated trajectory segment.

14. The method of claim 13, further comprising, in accordance with a determination that the updated trajectory segment does not intersect any of the respective trajectory segments of the other respective vehicles, initiating the departure of the vehicle from the downstream input buffer position to the parking spot along the updated trajectory segment.

15. A method of operating a transportation system, comprising:
at a control system configured to determine respective paths for respective vehicles and to provide the respective paths to the respective vehicles:
receiving a trip request specifying an origin boarding zone and a destination boarding zone;
selecting a vehicle for the trip request;
determining a deconflicted spacetime trajectory for the trip request, the deconflicted spacetime trajectory configured to avoid contact with other vehicles in the transportation system and extending from the origin boarding zone, along at least a portion of a trunk lane of a roadway system, to the destination boarding zone, the determining including:
for a first trajectory segment from a parking spot at the origin boarding zone to the trunk lane:
comparing the first trajectory segment to respective trajectory segments of other respective vehicles scheduled to travel in the origin boarding zone during a same time as the vehicle; and
selecting a departure time from the parking spot that results in the first trajectory segment avoiding all other respective trajectory segments; and
for a second trajectory segment along the trunk lane, the trunk lane associated with a set of moving position-targets that define non-intersecting vehicle positions along the trunk lane as a function of time:
selecting a moving position-target that is not assigned to another vehicle.

16. The method of claim 15, further comprising determining a path for the trip request, the path extending from the origin boarding zone to the destination boarding zone.

17. The method of claim 15, further comprising providing, to the vehicle, a parametric representation of the deconflicted spacetime trajectory that defines a position setpoint, a velocity setpoint, and an acceleration setpoint for the vehicle as a function of time.

18. The method of claim 17, wherein the parametric representation of the deconflicted spacetime trajectory is configured to cause the vehicle to traverse the first trajectory segment and the second trajectory segment.

19. The method of claim 15, further comprising causing the vehicle to begin traversing the deconflicted spacetime trajectory at the departure time.

20. The method of claim 15, wherein:
the vehicle is a first vehicle;
the parking spot is a first parking spot; and
the respective trajectory segments of the other respective vehicles include a third trajectory segment of a second vehicle that is travelling from the trunk lane to a second parking spot.
